(19) United States
(12) Patent Application Publication
(10) Pub. No.: US 2003/0050831 A1
(43) Pub. Date: Mar. 13, 2003

(54) SYSTEM FOR DISTRIBUTION AND REDEMPTION OF LOYALTY POINTS AND COUPONS

(76) Inventor: JOHN KLAYH, MANITOBA (CA)

Correspondence Address: SHAPRIO COHEN, P O BOX 3440, STATION D, OTTAWA, ONTARIO, K1P 6P1, CA

(21) Appl. No.: 09/218,019

(22) Filed: Dec. 22, 1998

(51) Int. Cl. G06F 7/00

(52) U.S. Cl. 705/14

(57) ABSTRACT

A system for controlling a customer reward system comprising: a first database for storing customer identifications, and for accumulated loyalty points awarded to the customer, an administration terminal for establishing loyalty point values associated with any of plural predetermined activities, and for storing the values and identities of associated activities, in a second database, a reading terminal for reading the identity of a customer at a location of the terminal, first apparatus located in the region of the reading terminal for detecting an activity of the customer, and second apparatus for accessing the second database, looking up the activity of the customer, and depositing corresponding loyalty points in the first database in association with an identification of the customer.

### FIELD OF THE INVENTION

This invention relates to the field of data communications, and in particular to a method and a system for on-line global distribution and redemption of loyalty points and coupons.

### BACKGROUND TO THE INVENTION

Electronic transaction processing and awarding of loyalty points by bank card issuers, airlines, etc. have come into widespread use. For example, retailers commonly use card swipe terminals which read information stored on a magnetic stripe carried by the card. The information is received by telephone line at an administration office, where a computer checks the credit of the customer identified by the information from a database, and provides an authorization number or denial of the transaction. Because credit is to be provided by the issuer of the card, such as a bank, the transaction is associated specifically with and is controlled by the issuer of the credit card.

As another example, when a debit card of a customer is swiped, a transaction value is keyed in by the retailer, and a PIN number is additionally keyed in by a user. The bank account of the user, the identity of which having been previously stored in association with the PIN number and card number, is accessed, and the transaction value is debited from the bank account. This amount (less a transaction charge) is credited to the bank account of the retailer identified when the debit card reader dialed to an administration office which is in association with the bank. In this case as well, the transaction is associated specifically with and is controlled by the issuer of the debit card.

It is common that some credit card issuers record loyalty points, for example a point for each dollar purchased on the credit card. These points are accumulated by the credit card issuer to the credit of the credit card user, and can be redeemed for merchandise typically advertised in a catalogue. In some cases, loyalty points are awarded by a vendor such as an airline, wherein the loyalty points can be used for airline travel with that airline. The vendor retains its own database of loyalty points accumulated against particular customers which have joined the loyalty point program.

In addition, identity cards rather than credit cards are sometimes used in the awarding of airline miles based on purchases from certain vendors. In this case as well, the card issuer retains a single database of airline points against customers.

In all such cases, the card issuer or the vendor (e.g. the airline) retains a simple database to keep track of the value of points accumulated or retained after redemption.

There is a single authority which has issued the card, and tie-ins of a single card with a limited number (often only one, and in some cases a large number) of merchants. For example, a card issuer may have a tie-in with several merchants to provide a discount on merchandise or services. In such a case, no loyalty points tied to a particular merchant are awarded to the customer for patronizing the merchant, but loyalty points can be awarded based on use of the card per se.

Further, the systems are not capable of dispensing or redeeming premiums or loyalty points “on-the-spot” for certain actions taken by customers, for example for patronizing certain merchants. Thus in this case as well, a single loyalty point database is associated with the card issuer, but not with the merchants. A merchant has no way of knowing whether a particular customer repeatedly purchases from that merchant.

In other words, such systems provide and record loyalty points related to use of a card, or to a single merchant, or to a single program (such as airline points), but do not provide loyalty points that can be traded between merchants or programs, and do not give incentive to patronize plural merchants as distinct from incentive to use a single card. The airline points programs which are not associated with a particular credit card also require the use of a single card, and loyalty points cannot be traded between merchants.

The systems are also not capable of accumulating prize values or loyalty points won on games played on game terminals, nor of dispensing prizes to players, e.g. loyalty points, premiums or plays on the games.

The systems are not capable of displaying advertising directed to specific customers who have identified themselves or have been identified at a terminal, nor for tracking what advertising has been displayed to particular customers, nor for controlling what advertising is shown to such customers.

Neither are the systems capable of allowing the loyalty points won or otherwise acquire to be used as a medium of exchange between member merchants, e.g. exchanging points won playing a video game for premiums which can be used at various merchants

### SUMMARY OF THE INVENTION

The present invention is an integrated on-line system which can accumulate and decrement exchange values associated with any customer from any merchant which has authorized access to the system or by an administrator or by plural authorized administrators. The awarded exchange values for any transaction can be controlled by an administrator or by authorized plural administrators, and can in addition be varied by location of the customer, by customer activity, by time and/or date, and by past history of either the activity itself or of the actions of the customer.

In addition, the administrator can vary the characteristics of a software program the customer, merchant, etc. is interacting with, so that loyalty points, advertisements, premiums, scores, game difficulty, and reward brackets, pricing by currency and/or loyalty point exchange, etc. can be controlled. The program can involve scoring of sporting events, scoring of school tests, operate applications such as email, etc. or it can be a video game such as one operating in a system of the type described in U.S. Pat. No. 5,083,271 issued Jan. 21, 1992, or on a personal or public computer (public PC). A user interface to the program can be displayed on a video terminal which can be one of the games described in the aforenoted U.S. patent, or on a personal or public computer, a display type or video telephone, a network computer interacting and communicating via a private network, the internet, cable or the equivalent, a telephone line, etc. The advertisement can be shown in one or more frames which share the display with a game, or can occupy the entire display area. The advertisement can be directed to a particular player, or to a class of customer to which the player belongs, and/or can be scheduled based on time and/or date and/or location at which it is to be presented. The advertisement can be changed based on various criteria, such as the location of the display, how many times it has been run, how many times it has been directed to the customer or class of customer at a particular display or display location or at plural particular or classes of locations or based on advertisements which have been shown to the customer in the past. Loyalty points (i.e. exchange values, which can include coupons, etc.) can be awarded based on an activity of the customer at least partly on the basis of his exposure to certain advertisements which may be displayed on the aforenoted displays.

Game programs can be changed and varied as to degree of difficulty and currency or exchange value price to participate, competition brackets can be set up and varied, thresholds for prizes can be established and varied, prize and premium values can be accumulated for various activities such as plays, purchases, loyalty, and/or timing, customers or players can be authorized or disqualified, advertising can be directed to certain customers or classes of customers, premiums can be accumulated and dispensed and prizes awarded across any kind of commercial or non-commercial activity with controllable interchangeability.

As an example, a customer can receive a coupon at a gasbar (or can play a newspaper game such as by reading an announcement in a newspaper) containing a question to be answered, and if answered correctly at a terminal used in the system described in this specification, a prize (e.g. a coupon for $1000 off the price of a purchase, or the awarding of loyalty points which can be exchanged for merchandise or service at participating or at all merchants) can be awarded by the system, and the accounts of the customer, merchants and administrator incremented or decremented as required.

The present invention thus provides for the first time an efficient way of combining loyalty point and premiums of any (rather than restricted) merchants, allows interchange of loyalty points, and at the same time gathers activity information about the customers of those merchants as an effective commercial measurement tool, and so that advertising may be targeted and efficiently delivered to those exact customers which can best benefit from the advertising.

By the use of the term merchants, included are merchants not only of merchandise, but also of services including the services of play of various games and contests.

In this specification, the term customer and subscriber will be used synonymously, since a customer which has been registered into the system becomes a subscriber, and it is the registered customer which can accumulate loyalty points.

In accordance with an embodiment of the present invention, a system for controlling a customer reward system comprises a first database which stores customer identifications and accumulated loyalty points awarded to the customer. An administration terminal establishes loyalty point values associated with any of plural predetermined activities, and provides the values and identities of associated activities for storage in a database. A reading terminal determines the identity of a customer at a location of the reading terminal. A first apparatus located in the region of the reading terminal detects an activity of the customer. Second apparatus accesses the second database, looks up the activity of the customer, and deposits corresponding loyalty points in the first database in association with an identification of the customer.

In accordance with another embodiment, a method of controlling a customer reward system comprises distributing identification elements to prospective customers each of which stores an unique customer identification. The presence of an identification element is subsequently detected at a terminal. Identification can be effected by reading a magnetic stripe on a card, reading a smart card, reading a bar code, voice analysis, eye iris detection, fingerprint or palmprint detection, etc. At least one of currency credits, loyalty point credits and coupon credits is received and stored in a database record associated with a customer identification based on at least one of a currency deposit and an activity undertaken by a customer. The loyalty points and coupon credits had been predetermined by an administrator and are variable depending on the activity undertaken by the customer and at least one of an identity of a merchant or machine which provides a product or a service, a total number or incremental number or skill level of persons which previously availed themselves of a product or service, a time interval or the real time when the product or service is provided, a skill bracket or handicapped skill achieved by the customer of an activity, a handicap attributed to a machine which provides a product or service, an interval since an activity was undertaken by the customer or by plural customers or by customers having a particular demographic profile, and a demographic profile of the customer.

In accordance with another embodiment, a method of controlling a customer reward system comprises: distributing identification elements to prospective customers each of which store unique customer identifications, detecting the presence of an identification element at a terminal, receiving and storing loyalty point credits in a database record associated with a customer identification based on at least one of a currency deposit and an activity undertaken by a customer, redeeming loyalty point credits by any of plural unrelated merchants at any of plural redemption terminals, reporting loyalty point credits and redemptions undertaken by each of the plural merchants to an administrator terminal via a comununication network, and settling credits and redemptions of loyalty points from time to time as between the merchants and administrator, whereby the loyalty points are used as a medium of exchange between the merchants and administrator via the network and the terminals.

In accordance with another embodiment, a method for controlling a customer reward system comprises:

(a) establishing merchant, customer and administrator loyalty point databases,

(b) depositing loyalty points in a designated customer's database or in plural customer databases,

(c) redeeming loyalty points of a customer by a merchant providing a goods or services, and decrementing the database of the customer by a predetermined number of loyalty points and incrementing the database of the merchant by the predetermined number of loyalty points,

(d) decrementing a further predetermined number of loyalty points from the database of the merchant and incrementing the database of the administrator by the further predetermined number of loyalty points.

In accordance with another embodiment, a method for controlling a customer reward system comprises:

(a) establishing merchant, customer and administrator loyalty point databases,

(b) depositing loyalty points in a designated customer's database or in plural customer databases,

(c) redeeming loyalty points of a customer by a merchant providing a goods or services, and decrementing the database of the customer by a first predetermined number of loyalty points and incrementing the database of the administrator by the first predetermined number of loyalty points, and

(d) decrementing a further predetermined number of loyalty points from the database of the administrator which is smaller than the first predetermined number of loyalty-points and incrementing the database of the merchant by the further predetermined number of loyalty points.

From time to time, in the above cases, values of loyalty points to monetary, merchandise or services values as between merchant and the administrator can be settled.

### BRIEF DESCRIPTION OF THE DRAWINGS

A better understanding of the invention will be obtained by a consideration of the detailed description below, in conjunction with the following drawings, in which:

FIG. 1 is a block diagram of a preferred embodiment of a system on which the present invention can be implemented, and

FIG. 2 is a flow chart of call initialization and loyalty point or coupon data interchange.

### DETAILED DESCRIPTION OF EMBODIMENTS OF THE INVENTION

U.S Pat. No. 5,083,271 is incorporated herein by reference. This patent describes plural game arcades which are in communication with a central computer, or with one of plural regional computers which communicate with a central computer. The regional computers receive game score data and compute tournament winners, downloading both winner information and advertising to local games at the game arcades.

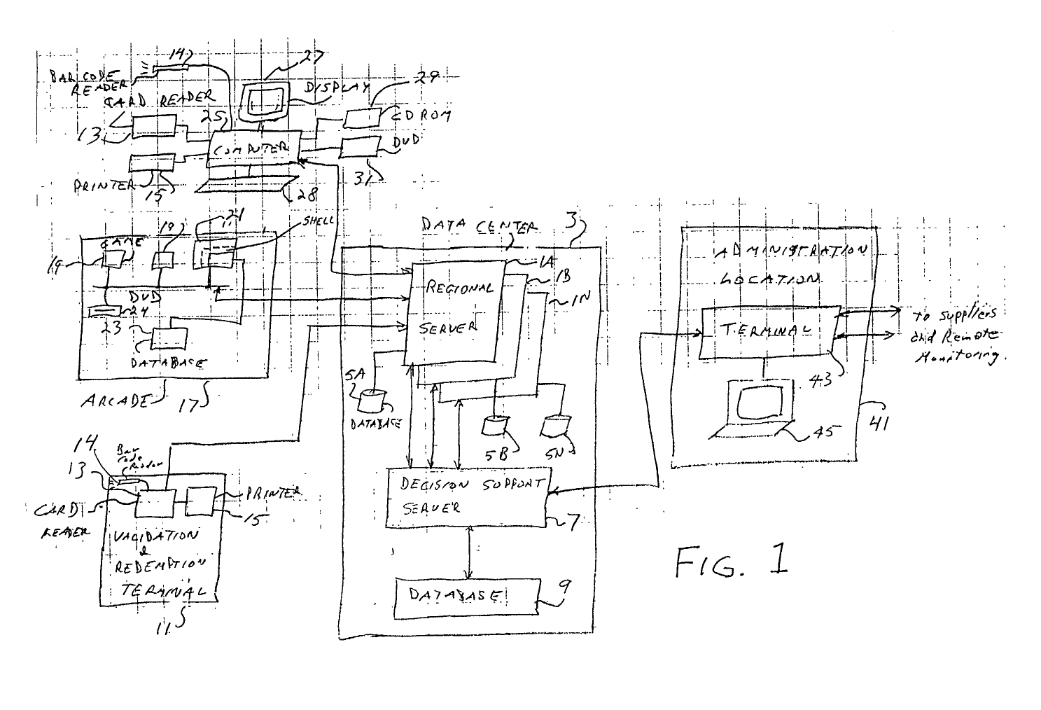

Turning to FIG. 1, in place of the regional computers, regional servers 1A, 1B . . . 1N, etc. are used. Each regional server is located at a separate regional data center, although for convenience of illustration they are all shown in this Figure in data center 3.

Each regional server has a memory containing a corresponding database 5A, 5B . . . 5N coupled to it. In the aforenoted patent, the corresponding memory stores not only score data, but also values of money on deposit to be credited against the playing of a game, and handicaps of players and/or games. If an activity other than playing a game is to be rewarded, the user activity can similarly be handicapped (for example, awarding of variable numbers of points for use of a particular long distance telephone supplier). In accordance with an embodiment of the invention, the databases 5A, 5B . . . 5N also store specialized data relating to parameters used in a game or activity, such as difficulty levels, points to be awarded for certain game activities, and other functions to be described in more detail below, as well as parameters and content relating to advertising, premiums, loyalty points, etc.

The data to be stored in databases 5A . . . 5N is loaded by a decision support server 7, from data stored in a database 9 with which it communicates.

Validation and redemption terminals 11 are in communication with the regional servers 1A . . . 1N. Each of the terminals 11 is comprised of a card reader 13 and preferably a bar code reader 14, smart card reader, or the equivalent, coupled to a printer 15. The card reader is preferably also a card writer for writing the magnetic stripe on a card and/or for updating, debiting or crediting one or more values stored on a smart card (a card which carries a processor or the equivalent and a memory). The term card reader is used in a general sense, since it can include a keypad or keyboard which can be used by the customer and/or merchant. The customer can also or alternatively be identified by a voice identifier, an eye iris reader, a fingerprint or palmprint reader, a keyed-in identity code such as a PIN number detector, etc., all of which are generically referred to herein as a card reader. The printer is used to print receipts and coupons, preferably including a bar code or the equivalent. The card reader can be based on the type made by Verifone Corp. for swiping cards and dialing a credit or debit card administration office.

A terminal 11 should be located at the premises of each associated merchant authorized to use the system, and can be located at one or plural arcades 17 or other single or multi-terminal system. A system, which can be, but is not limited to arcade 17 which is similar to the system described in the aforenoted patent is in communication with a corresponding server, in a manner as will be described later. However, rather than each game 19 communicating directly with a regional server via its own interface, it is preferred that it communicate with a regional server through a master game 21, via shell software which uses a particular communication protocol which can encrypt data. This will be described in more detail later. A database 23 is also coupled to the master game 21.

A computer 25, referred to below as a public PC 25, can be in communication with an associated regional server 1A . . . 1N. Preferably a card reader 13, bar code reader 14 and printer 15 are coupled to the computer, as well as a display 27, keyboard 28, game controls (e.g. joystick, mouse, trackball, fingerpad, pedals, etc.) a CD ROM player 29, and a DVD (digital versatile disk) player 31.

An administration office 41 contains a computer terminal 43 preferably operating in a Windows™ software environment, with a display 45. Rather than a Windows™ software environment, any type of operating system can be used, such as one which will operate under control of applets downloaded from the internet or any other network, Macintosh, OS/2, etc. The terminal 43 includes a database and a processor for controlling parameters of software used in the system, and can communicate with the decision support server 7 as will be described below.

In operation, games, advertising and parameters relating to loyalty points and/or coupons are downloaded under control of the decision support server 7 to database 9, then are distributed to regional servers 1A . . . 1N, then are downloaded to database 23. Alternatively the games, parameters and/or advertising are stored at the arcade 17 on local mass storage devices such as hard disk crives, digital versatile disks (DVDs) or CD ROMs (or can be stored in a semiconductor or any other form of mass storage memory), and are enabled from data stored in the decision support software. The games, parameters and/or advertising can be provided via applet if desired. In the description below, and only in this example, the games and advertising will be described as being stored on DVDs (in database 23). at the arcade. The database will be considered for this example to be a combination of the local mass storage and semiconductor memory, but it should be understood that the data can alternatively be downloaded from database 5A to 5N coupled to the regional server, and stored for use as needed in the database 23.

It is preferred that the games themselves should be written within a shell, with software “hooks” between the games and shell. The shell should be responsible for starting and stopping the game, altering its parameters, controlling the display of the game that is to be played, and communicating both with other games and with the regional server 1A . . . 1N. It is preferred that each of the games should communicate with the regional server only under control of the master game 21. The software operated by the master game 21 should in addition be designed to communicate with each of the games of the arcade, and with a designated regional server using a communications manager program, in accordance with a predetermined protocol.

Customer accounts are retained in the database 9, and are preferably comprised of the following fields:

1. Account data (customer name and PIN),

2. Balance of account (in currency), both current balance and pending balance (the latter being the expected balance after an ongoing transaction has been completed),

3. The identity and value of coupons and premiums allocated to the customer,

4. The balance value of loyalty points associated with the customer, e.g. as incremented or decremented by a device such as by an input device at a merchant location (for example by inputting via a keypad connected to the card reader 13 at a validation and redemption terminal 11) or by an administrator via terminal 43 at the administration location 41, or by operating an automatic terminal such as a coin telephone having a swipe card reader in administrative communication with regional server 1A to 1N, a game machine, etc.,

5. Game ratings, such as skill level of the customer for variously played games, handicap values of the customer for variously played games, profiles (e.g. how much time is allocated to the player to complete various games),

6. Viewing history of advertising (e.g. a record of the most recent time that the customer has viewed a particular advertisement),

7. Images displayed for this customer,

8. The identities of identification cards issued to the player,

9. Merchandise orders, e.g. the identity and loyalty point, premium or currency cost of merchandise that has been ordered, the date ordered, the date the order was sent to the supplier, the date the order was shipped, etc.,

10. The game play history, e.g. for each game played, the rank achieved, number of players in a game or tournament, etc.,

11. Data representing membership of the customer in competitions or teams,

12. Records of payments of fees made by the customer, and

13. Records of customer premiums and/or prizes awarded (which can be used e.g. for tax computation).

The administrator characterizes each game and activity relating to merchant products and services with certain parameters, and downloads these parameters from terminal 43 to server 7. For example;, the administrator establishes game formulae for each game, loyalty points (or none) for playing each game, for patronizing particular merchants, etc.

When a customer is issued an identity (ID) card, a PIN number is issued in a well known manner, and information re its issuance is uploaded from a validation terminal 11 to the associated regional server 1A to 1N. A record in the database 9 relating to this customer is established by server 7. The record is seeded by the parameters provided by the administration terminal to the server 7. For example, upon first initiation of the record, a number of loyalty points can be deposited to the customer, and recorded in the database in field 4.

The customer then pays currency to play say, 5 video games. The payment value is entered by swiping the ID card in a local card reader in the arcade, and by then entering the PIN number of the customer and the number of games to be played, or a currency amount into a local keypad. This amount is stored (deposited) in database field 1 (see the above field list) of database 9, after uploading from the arcade 17 via master game 21.

The customer then goes to the game and swipes his card in a card reader associated with the game. The request to initiate the game is sent to the game from the card reader, and value of the game play is sent to the decision support server 7. Server 7 addresses database 9, and selects the record of the customer from the card number read and provisionally decrements the amount on deposit, storing the resulting pending balance. If the game is not played (e.g. if there is a power outage), the pending balance is again incremented back to the previous balance after a predetermined amount of time. By using a central decision support server 7 and database 9 to store the customer accounts, the customer can be provided with service at any location which communicates with any regional server. A duplicate account is established and retained in the regional support server database 5A . . . 5N, the records being mutually updated (synchronized) from time to time.

At the time of establishment of the record in database e.g. 5A, the server 7 would also store values in the remaining fields of the record. For example, it would store an advertisement value, to be described in more detail below, in field 6, indicating that no ads have been presented to the customer.

After the customer has swiped his card at a game, and thus in this way or in another way described above identifies himself, the local database provides a data message to the local system which enables the selected game. It also enables a DVD to run an advertisement to the game via its shell, which overlays the game in a window, or is presented prior to or with the initial, intermediate or final screens of the game. For example, the initial screen can be a “welcome to a new player” screen, with an advertisement relating to one or another of the associated merchants. The advertisements to be run are pre-established at the administration terminal 43.

The fact of running a particular advertisement and of the customer being located at a particular game (determined from his ID card) is then stored in the 10^{th} field of the record. When the game has been completed, the score is uploaded to the regional server and the rank of the player is established and is stored in the 10^{th} field. The number of plays of the player of that game, and of other games, are also stored in the 10^{th} field. On the basis of this, depending on the administrator, loyalty points, coupons or premiums can be provided to the customer.

For example, if the customer has achieved a particular score, a predetermined number of loyalty points can be awarded, and added to those in the balance in the 4^{th} field of the database record. A printer 15 can dispense a coupon to the customer e.g. for a discount on a food item at a fast food outlet, the serial number and value of which is recorded in the 3^{rd} field of the record. The printout can also record the score and the game that was played.

The identity of the advertisement which was run is recorded in the 6^{th} field of the record.

The customer in achieving a particular amount of expertise can be handicapped by the software in the regional server 1A, and the handicap value recorded in the 5^{th} field of the record, the rank achieved recorded in the 10^{th} field, and all of this information can be printed on the same ticket as the coupon, or another ticket.

Now assume that the player attends a different arcade, and wishes to play a game. He will swipe his ID card in the local card reader, press a button to command the start of or the identity of the game if necessary, and his identity, a command to play a game and the cost to play is uploaded to the associated regional server, say server 1B. Server 1B searches its database 5B for a record of the identified customer, and doesn't find it. It then sends an inquiry to the server 7, which sends an inquiry to each of the other regional servers. Server 1A responds, and provides an indication to server 1B that the customer record is stored in a database associated with server 1A.

Server 1A then sends the record of the customer to server 1B via server 7. Server 1B checks whether the second field has sufficient balance to pay for the game. On the indication that it does, a provisional decrement is done as described earlier, and server 1B sends a signal to the master game of the arcade to enable the game.

The server 1B also checks the ad view history and image last viewed, and enables the DVD at the arcade to run the next advertisement in the predetermined sequence of advertisements to the game to be played, via the game shell. The entire process is repeated as described earlier.

In the event the customer has used the local system before, and his identity data, etc. is stored in the local database, the above process can be carried out using the data stored in the local database, rather than using the data stored in the server.

The score can result in loyalty points or premiums being awarded to the player, which are stored in the account of the player.

Assume now that the customer wishes to redeem loyalty points or premiums. The customer can visit a validation and redemption terminal, which can be at the location of a merchant, a public PC, or at an arcade. The ID card of the customer is read, and an attendant types in a request on a local keyboard such as 28 to obtain the number of loyalty points, or the identities of coupons or premiums held by the customer. This request is uploaded to the regional server, which reads the database e.g. 5A and accesses the record of the customer identified by the card (and PIN number, if desired). On verification by the regional server, the data stored in the fields of the information requested by the attendant are then downloaded to the local terminal, such as computer 25, and is displayed on display 27.

The customer can ask for redemption of the value of the coupon. For example, if the validation and redemption center is at a fast food outlet, and the coupon is for a discount on a hamburger from the fast food outlet, the merchant can sell the hamburger at the required discount, take the coupon from the customer, and key in the coupon on a keypad or read a barcode or magnetic stripe, or the equivalent, carried by the coupon, to identify it and record it as having been redeemed. The local computer or the equivalent then uploads this data to the regional server 1A, which records that the coupon has been rendered.

While this transaction is going on, there could be a display adjacent the redemption equipment. The regional server, in learning of the presence of the customer at that location from the ID card swipe, can then look up the advertisement viewing history from the 6^{th} field of the customer's record in the database, and send a control signal to the computer or the equivalent at the redemption center, to enable a local DVD 31 to run the next advertisement in a predetermined sequence to the display which is adjacent the customer. Loyalty points can be awarded to the identified customer based on viewing a particular advertisement, and stored in the database as described earlier.

In a similar manner, loyalty points can be redeemed. The customer can attend a redemption center which can be a merchant, or a special catalog store. After swiping the ID card of the customer and keying in a request to display the number of loyalty points accrued to the customer, the regional server e.g. 1A accesses the record of the customer using his ID and PIN number in database e.g. 5A, and downloads the information to a local display. Following redemption of a particular number of loyalty points for the merchandise or services requested, the 4^{th} field of the record of the customer is decremented by the value of the loyalty points redeemed.

It should be noted that the system is global, in that any merchant can have a redemption terminal. Upon redeeming loyalty points which have been accrued by the customer by playing games, viewing advertisements, or using services of other merchants, etc., the redeeming merchant can be owed a certain value based on the redemption. This value or the equivalent in loyalty points, can be stored (credited) in a database 5A related to the merchant. When a customer purchases goods from that merchant, a certain number of loyalty points can be awarded the customer, and the balance debited from the balance of the merchant. Administrator service fees in the form of loyalty points can be accrued to an account of the administrator for each transaction. In this manner, loyalty points become a medium of exchange for the customer, the merchants and the administrator.

Loyalty points or a monetary amount can be decremented from an account of each merchant for each play of its advertisement.

At the end of a predetermined period, for example quarterly, yearly, etc., the administrator and merchants can settle the accounts, e.g. collecting a prescribed monetary value for negative balances of merchant loyalty point accounts, and paying a prescribed monetary value for positive balances of merchant loyalty point accounts.

Loyalty points can also be redeemed by the customer for any merchandise or service at any merchant location or venue at which a service terminal is located, or for game play at an arcade.

Two types of data interchange are preferably used in the system: synchronous and asynchronous. In synchronous interchanges, the client initiates a connection to a server, sends a request, and await a reply, in a manner similar to credit card authorizations in retail stores. An example of this type of interchange in the present invention is the validation of a prize receipt. Asynchronous interchanges are used for database synchronization. They allow events that have been queued by clients to be sent to servers, and allow servers to add or update information in a client's database.

Four modes of communication between clients and servers are preferred to be used:

Queries from clients to servers for specific information,

Events being transmitted from clients to servers,

Record and file system synchronization transmitted from servers to clients, and

Interactive on-line traffic, allowing on-line services in which processing is done in real-time by the server, or through a proxy process on the server.

Because of the short duration and unpredictability of query calls, they are preferably implemented with a point-of-sale, packet type transaction type network, with dial-in connections from various client locations using a global toll-free number.

The remaining types of calls are more predictable in nature and duration, typically lasting one or more minutes, and preferably use full duplex stream-oriented communications. This can be implemented using a dedicated or non-dedicated dial-up line between client and server, using TCP/IP ports (internet or intranet).

Thus each server can initiate two types of connections to client servers: asynchronous dial-in to the transaction network at relatively low speeds (e.g. 2400 baud or higher) for short duration queries, or via a dial-in PPP connection (e.g. 28.8 kbaud or higher) or ISDN to perform sockets-based communication.

The data transmission protocol used is preferred to be bi-directional full-duplex asynchronous communication using X.25-based packet switching, but other communications technologies, e.g. ADSL, can be used, as they become widely available. Prior to application to the network, the event data should be packetized, inserted into variable length telecommunication packets, compressed and encrypted using the encryption key of the location. Other fields in the telecommunication packet need not be compressed or encrypted. The received packets should be decrypted, decompressed, and extracted from the telecommunication packets.

The transmissions are preferably initiated from the transmitting entity (dial-in) rather than being polled. The calls can be normal (e.g. to pass data re start, game plays, alarms, meters, etc. to and from the client, stored in a queue at that location for subsequent transmission), urgent (e.g. such as customer information when a card is swiped), and receipt validation (e.g. to verify calls used by validation terminals).

Terminals communicating within a single location can use 10baseT twisted pair wiring and 802.3 (Ethernet™) standard for data link management, or higher speed Ethernet or other technologies, as they become available. The regional servers can accept connections from either the point-of-sale transaction network or from a TCT/IP intemet/intranet connection (using Berkeley sockets). The same application-layer protocols operate over each connection, with the possible exception of synchronization, which can operate only over TCP/IP connections, if desired.

The four types of packets referred to above can have a number of subtypes, as follows:

| Packet Type: | Possible Subtypes: | |
|---|---|---|
| Control | Acknowledgment (ACK) | Negative Acknowledgment (NAK) |
| | Context Negotiation | Ping |
| | Ping Response | Open Query Link |
| | Close Query Link | Open IP Link |
| | Close IP Link | Link Status Request |
| | Link Status Response | Suspend Processing |
| | Suspend Processing Response | Resume Processing |
| | Resume Processing Response | Synchronize |
| | Synchronize Response | |
| Query | Test | Test Response |
| | Receipt Validation | Receipt Validation Response |
| | Subscriber Information | Subscriber Information Response |
| | Account Withdrawal | Account Withdrawal Response |
| | Account Deposit | Account Deposit Response |
| | Subscriber Account Data Request | Subscriber Account Data Response |
| | Winning Redemption Play | Winning Redemption Play Response |
| | Subscriber ID Request | Subscriber ID Response |
| | Credit/Debit Request | Credit/Debit Response |
| | Save State Request | Save State Response |
| | Restore State Request | Restore State Response |
| | New Subscriber Card Request | New Subscriber Card Response |
| | Reserve Merchandise | Reserve Merchandise Response |
| | Purchase Merchandise | Purchase Merchandise Response |
| | Release Merchandise | Release Merchandise Response |
| | Subscriber Ranking Request | Subscriber Ranking Response |
| Event | Alarm | Tournament Play |
| | Redemption Play | Meter Readings |
| | Ad Statistics | Service Accesses |
| | Down Times | New Subscriber |
| | New Team | Issued Coupons |
| | Loyalty Point Awards | |
| Synchronization | Inventory | Table Download |
| | File Initial Download | File Next Download |
| | File Initial Upload | File Next Upload |

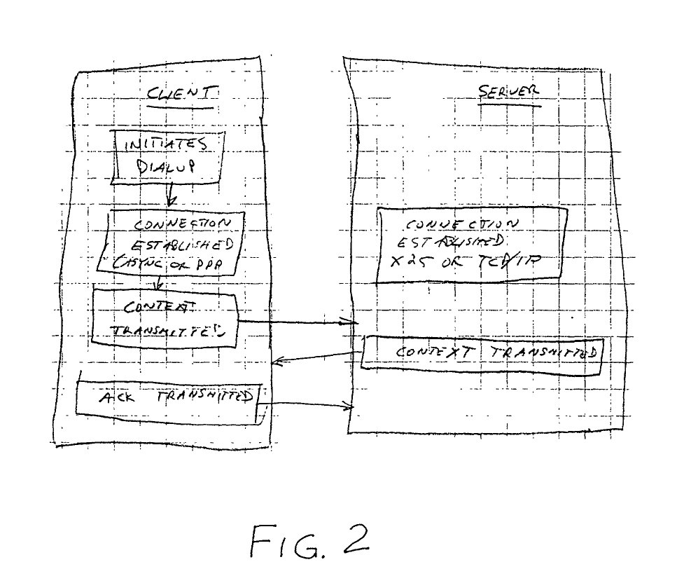

When a call is connected over the point of sale network or either of the TCP/IP ports, the client and server exchange context negotiation packets to configure the session communications as shown in FIG. 2. When both parties have acknowledged the context negotiation, data packets can begin.

The client sends a context negotiation packet with the settings it wishes to use for the call (including the encryption and compression parameters). This packet also tells the server what type of call this is (e.g. events, queries, etc.). The server examines the context negotiation packet and determines whether the values are acceptable. If so, it sends a context negotiation packet with the same settings to the client. The client acknowledges this packet to the server, and the call is considered to be established.

If the server cannot use the context provided by the client, it sends its own context negotiation packet back to the client with its preferred settings (e.g. a “lower” standard for compression or encryption). If the client agrees with these settings, it sends an acknowledgement to the server, and the call is considered to be established.

The contents of the context packet are sent uncompressed, but encrypted using the terminal's 16 byte license key and a TEA encryption algorithm. The terminal cannot operate unless the license key entered at the machine matches the key entered through the server administrative application.

If a device receives a context packet for an encryption method it can perform, it can NAK (unacknowlege) the packet. The server should retransmit session key packets, working from best to worst encryption (retrying a number of times in case of communications faults) until the client returns an acknowledgement. If the client never acknowledges the packet, the server should close the connection. Likewise, if the server never acknowledges the packet from the client, the client can close the connection. The client is free to retry with a new socket on the same call.

When a connection is established over the asynchronous point of sale link, the client may immediately begin transmitting data packets to the server. Then a PPP connection is established, the client should create a socket connection to one of the TCP ports listed above. Packets can then be sent over this socket connection. Multiple socket connections can be opened to allow parallel processing of synchronization, event and query traffic.

Query exchanges preferably occur in lockstep over a single connection. When a terminal issues a query, it waits on the same connection for a matching query response to arrive. The terminal then processes the query response, sends an acknowledgement, then closes the connection or continues with other query exchanges.

If a query initiates the download of table and/or file information to the client, the downloads should take place before the server sends the query response. When the query response is received at the client, it can assume that all downloads are complete.

Event transfer from clients to servers follows a lockstep acknowledgement cycle in which the client sends event packets and the server sends acknowledgement or nonacknowledgement packets in response. Events should remain in the client's event queue until an acknowledgement has been received from the server. When all events have been sent and acknowledged, the client can close the connection.

When a client makes a synchronization call, the client and server begin by exchanging inventory packets. The client sends an inventory of all data currently loaded, and the server sends an inventory of what the client should have (including table records and files).

The client should use the server's inventory to delete all records and files that are not present at the server. The server should use the client's inventory to build a set of table and file download packets to send new information to the client.

Once the inventories have been exchanged, the server should begin sending table and file download packets. The client should respond to these with either an acknowledgment or nonacknowledgement packet. When the server has sent all records, it should send a table download packet with 0 records to indicate the end of data. The client is free to close the connection at this point.

All packets should be framed with a consistent header and trailer, to allow the protocol processor in the receiving server or terminal to distinguish between different versions of requests. A preferred packet is as follows:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

For the synchronization function, assuming that the inventory of a customer is being downloaded, e.g. from a database associated with a regional server to a database associated with an arcade, public PC or validation and redemption terminal, the packets can add a field (e.g. 4 bytes) which identifies the customer.

The administration terminal 43 contains a database which specifies the entire system, in subdatabases which can be specified as classes. The content of the complete database, or the content of each subdatabase can be specified by a single administration entity, or any can be specified by authorized suppliers. In the latter case, the content of the subdatabases can be filled by communication between the terminal 43 and suppliers' terminals, using the system shown in FIG. 1.

Subdatabases are preferred to relate to the following:

| Suppliers Locations | |
|---|---|
| Game Machines | Game Software |
| Redemptions | Tournaments |
| Merchandise Categories | Pricing |
| Prizes | Alarms |
| Schedules Manufacturers | |
| Customers Technicians | |
| Advertising | Content |
| Coupons | Loyalty Programs |
| Promotions | Services |
| Profile Descriptor (e.g. VALs) | |

VAL™ is a standard profile descriptor which has been adopted by some companies. VALs or classification systems used by other companies can be stored and used in addition to or as a replacement for the demographic classification described herein.

Game Software is an example of the above. A field of the above can be the identification of a game which is located on a CD ROM, hard disk drive, DVD or mass semiconductor or other storage means at a game location. Another field can be an algorithm which controls the parameters of the game. Another field can store score brackets which a player must reach in order to win a prize. Another field can store timing information which can be used to modify the brackets. Other fields can be filled with other data required for the game.

The other subdatabases can be similarly filled with data to specify the operation of each parameter of the system. For example, a merchant can specify a premium related to the merchant's store as a prize to the player of a game at an arcade nearby to the store. A field in the prize or coupon subdatabase can point to the game or games for which the premium or coupon is to be distributed, another can specify a score bracket to be achieved (which can be >0) by the player in order to win the premium or coupon, etc.

Once the database has been completed to a required level, the subdatabases are downloaded to the decision support server 7, which stores it in its database 9. The decision support server then downloads the data as related to the various peripheral terminals to the associated regional servers, which in turn stores required data in their respective databases 5A to 5N, and downloads the data related to the respective terminals to those of concern.

As a further example, regional server 5A downloads initialization parameters to the master games 21 in the arcades in which authorized game machines are located which can communicate with the regional server 5A. It also downloads initialization parameters to the software at the public PCs with which it can communicate, which have been authorized at the administration location.

For example, the initialization parameters may initialize or authorize operation of particular video games, with particular score brackets, at the arcade 17 and at the public PC. The initialization parameters may also initialize a program at the public PC which controls acceptance of payments, and/or acceptance of orders for merchandise, and/or redemption of premiums, etc., and also controls transmission of data to the regional server which updates the account of the customer in currency or other media of exchange such as loyalty points, etc.

Table 1 which is attached at the end of this specification describes preferred subdatabases to be established initially at the administration terminal, which specify games, software, advertisements and other matters, and their parameters, which are downloaded to the terminals in a manner as described above. Each of the subdatabases is headed by a table name, and each of the fields describes the content of the field; its content and use are self evident from the name chosen.

It was noted above that parameters can be downloaded for the operation of a game. The shell of a game can have a requirement for score formulae to be inserted. The score formulae can be determined at the administration terminal, and downloaded as noted earlier, as one or more parameters of the game.

For example, consider the Pacman™ game. Key graphical elements of the game are dots, fruits, ghosts, and the game requires a scope value. The dots can be given a statistic S00, the fruits a statistic S01, the ghosts a statistic S02 and the scope a statistic S03.

A formula can be determined, e.g. (S00+5)*S03 to determine an output score for dots, for example. The scores can be used to alter the game, or to alter tournament derived scores. The formulae can be modified by a player rating depending on the player identified (e.g. a handicap or demographic indicator), a game handicap, or a predetermined algorithm.

In operation, as customer may attend a validation or redemption terminal location at the location of a merchant, or at an arcade, or at the location a public PC, and wish to enter credits, or wish to be registered in the system. Entering of credits can be effected by an attendant keying in relevant information to a terminal, sufficient to identify the person, e.g. name and address, etc., or the customer can perform the same function via an automatic terminal such as a card vending machine which provides instructions how to proceed. If there are no credits to be entered, the customer should choose a PIN number, which is recorded in a hidden manner (such as in a magnetic stripe or in the memory of a “smart card” carried on the card), and the card is dispensed or personally given to the customer. If a currency credit is to be posted, the customer will pay the attendant or deposit money into the card vending machine, which is recorded against the identity of the customer. The data entered into the terminal is then uploaded to the regional server e.g. 1A, and is stored in its associated database 5A.

The customer now will undertake certain activities, such as purchasing goods or services from any of the merchants registered in the system, or play games at the arcade. If the customer plays games at the arcade, and wishes to use the credit balance in his account to play, he will swipe his card in a card reader at the game, which identifies him and the value to be debited from his balance. If he wishes to purchase goods or services against his credit, or purchase a different service offered at the public PC (e.g. purchase printing or communication services) his card will be swiped in a card reader at the location of the merchant where he wishes to purchase the goods or services or at the public PC.

In any such case, the identity of the customer, the location of the customer, the identity of the merchant, game or public PC, and the amount of the debit will be uploaded into and stored in the database 5A after being recorded at the location (e.g. in database 23 if the transaction occurred at the arcade).

The administrator had already entered into its database using terminal 43 loyalty point values for certain activities, which had been downloaded and stored at database 9, and then loaded to databases 5A . . . 5N. Therefore for each activity undertaken by the customer for which loyalty points are to be awarded, they are credited to the customer's account stored in the customer's database of the regional server. These loyalty points can then be used as a form of scrip by the customer, apart from, or with cash deposits.

In addition, the administrator can specify and store records in the aforenoted databases that premium coupons should be dispensed for the customer at the determined location of the customer via a local printer, for defined activities undertaken by the customer.

Loyalty points, game credits for future play and/or coupons can also be awarded to the account of the customer and/or dispensed when predetermined scores or score brackets are achieved on the games (whether due to individual play or in tournaments) by the identified customer player.

The amounts of the loyalty points, game credits or coupons can be varied by time, by location, by number of players having played the game or tournament within a certain time interval or within certain clock times, by number of players, by demographic of the player, by difficulty of the game, by game handicap, etc. All such variations can be established at the administration location by means of a matrix (or form) to be filled in, such as shown in Table I attached hereto and forming part of this specification, and stored in the databases as described above. Indeed, the administrator can indicate a conversion of loyalty points to currency, for redemption or for use to purchase goods of particular ones or of any goods or services provided by member merchants.

When a customer wishes to redeem a coupon, the customer presents it to a merchant, public pc operator, public pc, etc., its bar code is read by a bar code reader at a validation and redemption terminal, and the customer's identification is read from his card by a card reader, at the validation and redemption terminal. The identification (and value, if desired for greater security) of the coupon is uploaded to the regional server, and the database is accessed using the identification of the customer. The identity of the coupon is then checked in the customer's record, and if the coupon had been validly recorded, a message is sent to the validation and redemption terminal acknowledging the validity of the transaction. An acknowledgement is entered into the terminal and is uploaded to the regional server, which either marks the coupon record as having been used, or deletes it from the customer's record. In either case, information of the awarding, and subsequently of the redemption of the coupon, is entered to database 9 via the decision support server, to provide a statistical report to terminal 43 either immediately or from time to time as to volumes and identities of services used by the customer or by groups of customers, by demographics, etc. and coupons and loyalty points awarded and redeemed, and the identity of the merchant or terminal performing the redemption.

These statistics provide a good measure for the administrator to be able to use for reporting and/or advertising of the benefits of the system to prospective merchants and others which may wish to advertise on the system or which may wish to include their goods, services and locations as part of the system. In addition, it provides the information to the administrator for settling the merchants' accounts, as described earlier. The loyalty points thus have been used as a medium of exchange separate from currency.

It should be noted that while the description herein is to a client-server type system which communicate in a particular manner, the equivalent function and structure of the invention could also be realized by persons skilled in the art understanding this invention via one or more browsers which interface one or more web pages, either via the internet or on one or more intranets which are either self-contained or which communicate via the internet, or via private network.

A person understanding this invention may now conceive of alternate embodiments and enhancements using the principles described herein. All such embodiments and enhancements are considered to be within the spirit and scope of this invention as defined in the claims appended hereto.

# initdb.ini
#
# NOTES:
# 1. Database name cannot exceed 23 characters
# 2. Allowed data types are LONG, SHORT, BIN, VARBIN
# 3. Table names cannot exceed 23 characters
# 4. Field names cannot exceed 23 characters
# 5. Arrays of SHORT and LONG are not supported (set size = 1)
# 6. Variable binary fields as primary keys is not supported
# 7. Each table can have only one variable binary field
# 8. Variable binary field myst be last field in table
# 9. Variable binary field must be preceded by SHORT size field
# 10. File created will be database name with “.db” appended
# 11. Tables cannot exceed 32 fields

| DATABSE | = ADMIN | | |
|---|---|---|---|
| TABLE | = AD | | |
| FIELD | = RECORD_ID | : BIN | : 6 : PK |
| FIELD | = AD_ID | : LONG | : 1 |
| FIELD | = CONTENT_ID | : LONG | : 1 |
| FIELD | = PRECEDING_AD_ID | : LONG | : 1 |
| FIELD | = NEXT_AD_ID | : LONG | : 1 |
| FIELD | = MAX_VIEWS_PER_PERSON | : SHORT | : 1 |
| FIELD | = FLAGS | : BIN | : 1 |
| TABLE | = AD_SCHEDULE | | |
| FIELD | = RECORD_ID | : BIN | : 6 : PK |
| FIELD | = AD_ID | : LONG | : 1 |
| FIELD | = TERMINAL_ID | : BIN | : 6 |
| FIELD | = SCHEDULE_ID | : LONG | : 1 |
| FIELD | = FLAGS | : BIN | : 1 |
| TABLE | = AD_TARGET | | |
| FIELD | = RECORD_ID | : BIN | : 6 : PK |
| FIELD | = TARGET_ID | : LONG | : 1 |
| FIELD | = AD_ID | : LONG | : 1 |
| FIELD | = TARGET_TYPE | : BIN | : 1 |
| FIELD | = TARGET_EVENT_ID | : LONG | : 1 |
| FIELD | = TARGET_SERVICE_{—ID} | : LONG | : 1 |
| FIELD | = SLOT | : BIN | : 1 |
| FILED | = PRIORITY | : BIN | : 1 |
| FIELD | = MIN_DAILY_EXPOSURES | : SHORT | : 1 |
| FIELD | = MAX_DAILY_EXPOSURES | : SHORT | : 1 |
| FIELD | = MIN_TOTAL_EXPOSURES | : LONG | : 1 |
| FIELD | = MAX_TOTAL_EXPOSURES | : LONG | : 1 |
| FIELD | = FLAGS | : BIN | : 1 |
| TABLE | = AD_TARGET_DEMOGRAPHIC | | |
| FIELD | = RECORD_ID | : BIN | : 6 : PK |
| FIELD | = TARGET_ID | : LONG | : 1 |
| FIELD | = DEMOGRAPHIC | : LONG | : 1 |
| FIELD | = FLAGS | : BIN | : 1 |
| TABLE | = AD_TARGET_PROMOTION | | |
| FIELD | = RECORD_ID | : BIN | : 6 : PK |
| FIELD | = TARGET_ID | : LONG | : 1 |
| FIELD | = PROMOTION_ID | : LONG | : 1 |
| FIELD | = FLAGS | : BIN | : 1 |
| TABLE | = AD_URC | | |
| FIELD | = RECORD_ID | : BIN | : 6 : PK |
| FIELD | = AD_ID | : LONG | : 1 |
| FIELD | = URC | : LONG | : 1 |
| FIELD | = FLAGS | : BIN | : 1 |
| TABLE | = ALARM_HANDLER | | |
| FIELD | = RECORD_ID | : BIN | : 6 : PK |
| FIELD | = HANDLER_ID | : LONG | : 1 |
| FIELD | = ALARM_CODE | : BIN | : 1 |
| FIELD | = PRIORITY | : BIN | : 1 |
| FIELD | = PROCESS_TYPE | : BIN | : 1 |
| FIELD | = FLAGS | : BIN | : 1 |
| FIELD | = PROCESS_DATA_SIZE | : SHORT | : 1 |
| FIELD | = PROCESS_DATA | : VARBIN | : 1 |
| TABLE | = BRACKET | | |
| FIELD | = RECORD_ID | : BIN | : 6 : PK |
| FIELD | = TOURNAMENT_ID | : LONG | : 1 |
| FIELD | = BRACKET_ID | : BIN | : 1 |
| FIELD | = SHORT_NAME | : BIN | : 28 |
| FIELD | = NAME | : BIN : 72 | |
| FIELD | = START_DATE_TIME | : LONG | : 1 |
| FIELD | = END_DATE_TIME | : LONG | : 1 |
| FIELD | = SCORE_POSITION_TIME | : LONG | : 1 |
| FIELD | = ENTRY_PRICE | : LONG | : 1 |
| FIELD | = PREPAID_PLAYS | : SHORT | : 1 |
| FIELD | = MIN_GAMES_PER_PLAYER | : SHORT | : 1 |
| FIELD | = MAX_GAMES_PER_PLAYER | : SHORT | : 1 |
| FIELD | = MIN_GAMES_PER_PLAYER | : SHORT | : 1 |
| FIELD | = LEADERBOARD_ID | : LONG | : 1 |
| FIELD | = SPONSOR | : BIN | : 40 |
| FIELD | = ICON | : LONG | : 1 |
| FIELD | = SPLASH_SCREEN | : LONG | : 1 |
| FIELD | = FLAGS | : BIN | : 1 |
| FIELD | = RANKING_ALGORITHM | : BIN | : 1 |
| TABLE | = BRACKET_ADVANCE | | |
| FIELD | = RECORD_ID | : BIN | : 6 : PK |
| FIELD | = TOURNAMENT_ | : LONG | : 1 |
| FIELD | = BRACKET_ID | : BIN | : 1 |
| FIELD | = ADVANCE_TYPE | : BIN | : 1 |
| FIELD | = FROM_TOURNAMENT_ID | : LONG | : 1 |
| FIELD | = FROM_BRACKET_ID | : BIN | : 1 |
| FIELD | = FROM_LOW | : LONG | : 1 |
| FIELD | = TO_HIGH | : LONG | : 1 |
| FIELD | = SERVICE_ID | : LONG | : 1 |
| FIELD | = PROFILE | : BIN | : 1 |
| FIELD | = FLAGS | : BIN | : 1 |
| TABLE | = BRACKET_MEMBERSHIP | | |
| FIELD | = RECORD_ID | : BIN | : 6 : PK |
| FIELD | = TOURNAMENT_ | : LONG | : 1 |
| FIELD | = BRACKET_ID | : BIN | : 1 |
| FIELD | = SUBSCRIBER_ID | : LONG | : 1 |
| FIELD | = FLAGS | : BIN | : 1 |
| TABLE | = BRACKET PRIZE | | |
| FIELD | = RECORD_YD | : BIN | : 6 : PR |
| FIELD | = TOURNAMENT_ID | : LONG | : 1 |
| FIELD | = BRACKET_ID | : BIN | : 1 |
| FIELD | = PRIZE_ITEM_ID | : LONG | : 1 |
| FIELD | = PRIZE_PERCENT_OF_POOL | : BIN | : 1 |
| FIELD | = WINNING_PLACE | : BIN | : 1 |
| FIELD | = PLACE_NAME | : BIN | : 20 |
| FIELD | = NUM_WINNERS | : LONG | : 1 |
| FIELD | = EXPIRATION_DATE | : LONG | : 1 |
| FIELD | = FLAGS | : BIN | : 1 |
| TABLE | = BRACKET_PROMOTION | | |
| FIELD | = RECORD_ID | : BIN | : 6 : PK |
| FIELD | = TOURNAMENT_ID | : LONG | : 1 |
| FIELD | = BRACKET_ID | : BIN | : 1 |
| FIELD | = PROMOTION_ID | : LONG | : 1 |
| FIELD | = FLAGS | : BIN | : 1 |
| FIELD | = HIM_RANK | : SHORT | : 1 |
| TABLE | = BRACKET_RULE_SCREEN | | |
| FIELD | = RECORD_ID | : BIN | : 6 : PK |
| FIELD | = TOURNAMENT_ID | : LONG | : 1 |
| FIELD | = BRACKET_ID | : BIN | : 1 |
| FIELD | = SERVICE_ID | : LONG | : 1 |
| FIELD | = SCREEN_INDEX | : BIN | : 1 |
| FIELD | = CONTENT_ID | : LONG | : 1 |
| FIELD | = FLAGS | : BIN | : 1 |
| TABLE | = BRACKET_SCHEDULE | | |
| FIELD | = RECORD_ID | : BIN | : 6 : PK |
| FIELD | = TOURNAMENT_ID | : LONG | : 1 |
| FIELD | = BRACKET_ID | : BIN | : 1 |
| FIELD | = TERMINAL_ID | : BIN | : 6 |
| FIELD | = SCHEDULE__ID | : LONG | : 1 |
| FIELD | = FLAGS | : BIN | : 1 |
| FIELD | = NUM_LOCAL_LEADERS | : SHORT | : 1 |
| TABLE | = BRACKET_SERVICE | | |
| FIELD | = RECORD_ID | : BIN | : 6 : PK |
| FIELD | = TOURNAMENT_ID | : LONG | : 1 |
| FIELD | = BRACKET_ID | : BIN | : 1 |
| FIELD | = SERVICE_ID | : LONG | : 1 |
| FIELD | = PROFILE | : BIN | : 1 |
| FIELD | = PRICING_ID | : LONG | : 1 |
| FIELD | = FLAGS | : BIN | : 1 |
| FIELD | = MIN_RATING_ALLOWED | : BIN | : 1 |
| FIELD | = MAX_RATING_ALLOWED | : BIN | : 1 |
| TABLE | = CATALOG_CATEGORY | | |
| FIELD | = RECORD_ID | : BIN | : 6 : PK |
| FIELD | = CATEGORY_ID | : LONG | : 1 |
| FIELD | = CATEGORY_NAME | : BIN | : 40 |
| FIELD | = PARENT_CATEGORY_ID | : LONG | : 1 |
| FIELD | = ICON | : LONG | : 1 |
| FIELD | = FLAGS | : BIN | : 1 |
| TABLE | = CATALOG_CATEGORY_URC | | |
| FIELD | = RECORD_ID | : BIN | : 6 : PK |
| FIELD | = CATEGORY_ID | : LONG | : 1 |
| FIELD | = URC | : LONG | : 1 |
| FIELD | = FLAGS | : BIN | : 1 |
| TABLE | = CONTENT | | |
| FIELD | = RECORD_ID | : BIN : 6 | : PK |
| FIELD | = CONTENT_ID | | |
| FIELD | = FORMAT | : BIN | : 1 |
| FIELD | = DURATION_MS | : LONG | : 1 |
| FIELD | = PATHNAME | : BIN | : 60 |
| FIELD | = FILE_SIZE | : LONG | : 1 |
| FIELD | = CRC | : SHORT | : 1 |
| FIELD | = FILE_TIMESTAMP | : LONG | : 1 |
| FIELD | = FLAGS | : BIN | : 1 |
| TABLE | = COUPON | | |
| FIELD | = RECORD_ID | : BIN | : 6 |
| FIELD | = COUPON_ID | : LONG | : 1 |
| FIELD | = DESCRIPTION | : BIN | : 40 |
| FIELD | = CONTENT_ID | : LONG | : 1 |
| FIELD | = UPC_SYMBOL | : BIN | : 12 |
| FIELD | = FACE_VALUE | : LONG | : 1 |
| FIELD | = MAX_ISSUED_PER_PLAYER | : SHORT | : 1 |
| FIELD | = FLAGS | : BIN | : 1 |
| TABLE | = COUPON_ITEM_SCHEDULE | | |
| FIELD | = RECORD_ID | : BIN | : 6 : PK |
| FIELD | = COUPON_ID | : LONG | : 1 |
| FIELD | = ITEM_ID | : LONG | : 1 |
| FIELD | = TERMINAL_ID | : BIN | 6 |
| FIELD | = SCHEDULE_ID | : LONG | : 1 |
| FIELD | = COUPON_CASH_VALUE | : LONG | : 1 |
| FIELD | = COUPON_PRICE | : LONG | : 1 |
| FIELD | = NUN_ITEMS_PER_COUPON | : SHORT | : 1 |
| FIELD | = MAX_REDEEMED | : BIN | : 1 |
| FIELD | = FLAGS | : BIN | : 1 |
| TABLE | = COUPON_SERVICE_SCHEDULE | | |
| FIELD | = RECORD_ID | : BIN | : 6 : PK |
| FIELD | = COUPON_ID | : LONG | : 1 |
| FIELD | = SERVICE_ID | : LONG | : 1 |
| FIELD | = TERMINAL_ID | : BIN | : 6 |
| FIELD | = SCHEDULE_ID | : LONG | : 1 |
| FIELD | = COUPON_CASH_VALUE | : LONG | : 1 |
| FIELD | = COUPON_PRICE | : LONG | : 1 |
| FIELD | = MUM_PLAYS_PER_COUPON | : SHORT | : 1 |
| FIELD | = MAX_REDEEMED | : SHORT | : 1 |
| FIELD | = FLAGS | : BIN | : 1 |
| TABLE | = FILE_INFO | | |
| FIELD | = RECORD_ID | : BIN | : 6 : PK |
| FIELD | = FILE_ID | : LONG | : 1 |
| FIELD | = FILESET_ID | : LONG | : 1 |
| FIELD | = PATHNAME | : BIN | : 60 |
| FIELD | = FILE_SIZE | : LONG | : 1 |
| FIELD | = CRC | : SHORT | : 1 |
| FIELD | = FILE_TIMESTAMP | : LONG | : 1 |
| FIELD | = FLAGS | : BIN | : 1 |
| TABLE | = ITEM | | |
| FIELD | = RECORD_ID | : BIN | : 6 : PK |
| FIELD | = ITEM_ID | : LONG | : 1 |
| FIELD | = CATEGORY_ID | : LONG | : 1 |
| FIELD | = ITEM_NAME | : BIN | : 40 |
| FIELD | = MIN_PRICE | : LONG | : 1 |
| FIELD | = MAX_PRICE | : LONG | : 1 |
| FIELD | = ICON | : LONG | : 1 |
| FIELD | = FLAGS | : BIN | : 1 |
| FIELD | = ITEM_COST | : LONG | : 1 |
| FIELD | = RETAIL_PRICE | : LONG | : 1 |
| FIELD | = QUANTITY_ON_HAND | : LONG | : 1 |
| FIELD | = MIN_QUANTITY_ON_HAND | : LONG | : 1 |
| FIELD | = DISTRIBUTION_LOCATION | : BIN | : 40 |
| TABLE | = ITEM_ATTRIBUTE | | |
| FIELD | = RECORD_ID | : BIN | : 6 : PK |
| FIELD | = ITEM_ID: : LONG | : 1 | |
| FIELD | = ATTRIBUTE_ID | : BIN | : 1 |
| FIELD | = ATTRIBUTE_NAME | : BIN | : 40 |
| FIELD | = DATA_TYPE | : BIN | : 1 |
| FIELD | = MINIMUM | : LONG | : 1 |
| FIELD | = MAXINUM | : LONG | : 1 |
| FIELD | = FLAGS | : BIN | : 1 |
| TABLE | = ITEM_ATTRIBUTE_VALUE | | |
| FIELD | = RECORD_ID | : BIN | : 6 : PK |
| FIELD | = ITEM_ID | : LONG | : 1 |
| FIELD | = ATTRIBUTE_ID | : BIN | : 1 |
| FIELD | = VALUE_INDEX | : BIN | : 1 |
| FIELD | = VALUE_TEXT | : BIN | : 30 |
| FIELD | = FLAGS | : BIN | : 1 |
| TABLE | = ITEM_PROMOTION | | |
| FIELD | = RECORD_ID | : BIN | : 6 : PK |
| FIELD | = ITEM_ID | : LONG | : 1 |
| FIELD | = PROMOTION_ID | : LONG | : 1 |
| FIELD | = FLAGS | : BIN | : 1 |
| TABLE | = ITEM_SCHEDULE | | |
| FIELD | = RECORD_ID | : BIN | : 6 : PK |
| FIELD | = ITEM_ID | : LONG | : 1 |
| FIELD | = TERMINAL_ID | : BIN | : 6 |
| FIELD | = SCHEDULE_ID | : LONG | : 1 |
| FIELD | = FLAGS | : BIN | : 1 |
| TABLE | = ITEM_SCREEN | | |
| FIELD | = RECORD_ID | : BIN | : 6 : PK |
| FIELD | = ITEM_ID | : LONG | : 1 |
| FIELD | = SCREEN_INDEX | : BIN | : 1 |
| FIELD | = CONTENT_ID | : LONG | : 1 |
| FIELD | = FLAGS | : BIN | : 1 |
| TABLE | = ITEM_URC | | |
| FIELD | = RECORD_ID | : BIN | : 6 : PK |
| FIELD | = ITEM_ID | : LONG | : 1 |
| FIELD | = URC | : LONG | : 1 |
| FIELD | = FLAGS | : BIN | : 1 |
| TABLE | = LEADERBOARD | | |
| FIELD | = RECORD_ID | : BIN | : 6 : PK |
| FIELD | = LEADERBOARD_ | : LONG | : 1 |
| FIELD | = LEADERBOARD_DATE_TIME | : LONG | : 1 |
| FIELD | = FLAGS | : BIN | : 1 |
| FIELD | = MAX_LEADERS | : SHORT | : 1 |
| TABLE | = LEADERBOARD_LEADER | | |
| FIELD | = RECORD_ID | : BIN | : 6 : PK |
| FIELD | = LEADERBOARD_ID | : LONG | : 1 |
| FIELD | = SUBSCRIBER_ID | : LONG | : 1 |
| FIELD | = ALIAS | : BIN | : 26 |
| FIELD | = LOCATION_NAME | : BIN | : 26 |
| FIELD | = LOCATION_CITY_STATE | : BIN | : 26 |
| FIELD | = PRIZE_NAME | : BIN | : 26 |
| FIELD | = SCORE | : LONG | : 1 |
| FIELD | = SCORE_DATE_TIME | : LONG | : 1 |
| FIELD | = FLAGS | : BIN | : 1 |
| TABLE | = LEADERBOARD_RANKING | | |
| FIELD | = RECORD_ID | : BIN | : 6 : PK |
| FIELD | = LEADERBOARD_ID | : LONG | : 1 |
| FIELD | = RANK | : SHORT | : 1 |
| FIELD | = SUBSCRIBER_ID | : LONG | : 1 |
| FIELD | = FLAGS | : BIN | : 1 |
| TABLE | = LOCATION | | |
| FIELD | = RECORD_ID | : BIN | : 6 : PK |
| FIELD | = LOCATION_ID | : LONG | : 1 |
| FIELD | = SHORT_NAME | : BIN | : 26 |
| FIELD | = NAME | : BIN | : 72 |
| FIELD | = SHORT_CITY_STATE | : BIN | : 26 |
| FIELD | = CITY_STATE | : BIN | : 72 |
| FIELD | = TIME_ZONE | : BIN | : 1 |
| FIELD | = MAX_DAILY_PAYOUT | : LONG | : 1 |
| FIELD | = DIALIN_INTERVAL | : LONG | : 1 |
| FIELD | = LANGUAGE_CODE | : SHORT | : 1 |
| FIELD | = COUNTRY_CODE | : SHORT | : 1 |
| FIELD | = FLAGS | : BIN | : 1 |
| FIELD | = TOKEN_PRICE | : LONG | : 1 |
| TABLE | = LOCATION_ATTRACT_SCREEN | | |
| FIELD | = RECORD_ID | : BIN | : 6 : PK |
| FIELD | = LOCATION_ID | : LONG | : 1 |
| FIELD | = SCREEN_INDEX | : BIN | : 1 |
| FIELD | = CONTENT_ID | : LONG | : 1 |
| FIELD | = FLAGS | : BIN | : 1 |
| TABLE | = LOCATION_COUPON_SCHED | | |
| FIELD | = RECORD_ID | : BIN | : 6 : PK |
| FIELD | = LOCATION_ID | : LONG | : 1 |
| FIELD | = COUPON_ID | : LONG | : 1 |
| FIELD | = SCHEDULE_ID | : LONG | : 1 |
| FIELD | = COUPON_PRICE | : LONG | : 1 |
| FIELD | = FLAGS | : BIN | : 1 |
| TABLE | = LOCATION_LOYALTY_SCHED | | |
| FIELD | = RECORD_ID | : BIN | : 6 : PK |
| FIELD | = LOCATION_ID | : LONG | : 1 |
| FIELD | = LOYALTY PROGRAM_ID | | |
| FIELD | = SCHEDULE_ID | : LONG | : 1 |
| FIELD | = POINT_PRICE | : LONG | : 1 |
| FIELD | = FLAGS | : BIN | : 1 |
| TABLE | = LOCATION_URC | | |
| FIELD | = RECORD_ID | : BIN | : 6 : PK |
| FIELD | = LOCATION_ID | : LONG | : 1 |
| FIELD | = URC | : LONG | : 1 |
| FIELD | = FLAGS | : BIN | : 1 |
| TABLE | = LOYALTY_PROGRAM | | |
| FIELD | = RECORD_ID | : BIN | : 6 |
| FIELD | = LOYALTY_PROGRAM_ID | : LONG | : 1 |
| FIELD | = NAME | : BIN | : 40 |
| FIELD | POINT_LABEL : BIN | : 20 | |
| FIELD | FLAGS | : BIN | : 1 |
| TABLE | = LOYALTY_ITEM_SCHED | | |
| FIELD | = RECORD_ID | : BIN | : 6 : PK |
| FIELD | = LOYALTY_PROGRAM_ID | : LONG | : 1 |
| FIELD | = ITEM_ID | : LONG | : 1 |
| FIELD | = TERMINAL_ID | : BIN | : 6 |
| FIELD | = SCHEDULE_ID | : LONG | : 1 |
| FIELD | = POINT_CASH_VALUE | : LONG | : 1 |
| FIELD | = POINT_PRICE | : LONG | : 1 |
| FIELD | = POINTS_PER_ITEM | : SHORT | : 1 |
| FIELD | = ITEMS_PER_POINT | : SHORT | : 1 |
| FIELD | = MAX_USED_PER_ITEM | : SHORT | : 1 |
| FIELD | = FLAGS | : BIN | : 1 |
| TABLE | = LOYALTY_SERVICE_SCHED | | |
| FIELD | = RECORD_ID | : BIN | : 6 : PK |
| FIELD | = LOYALTY_PROGRAM_ID | : LONG | : 1 |
| FIELD | = SERVICE_ID | : LONG | : 1 |
| FIELD | = TERMINAL_ID | : BIN | : 6 |
| FIELD | = SCHEDULE_ID | : LONG | : 1 |
| FIELD | = POINT_CASH_VALUE | : LONG | : 1 |
| FIELD | = POINT_PRICE | : LONG | : 1 |
| FIELD | = POINTS_PER_PLAY | : SHORT | : 1 |
| FIELD | = PLAYS_PER_POINT | : SHORT | : 1 |
| FIELD | = MAX_USED_PER_PLAY | : SHORT | : 1 |
| FIELD | = FLAGS | : BIN : 1 | |
| TABLE | = PRICING | | |
| FIELD | = RECORD_ID | : BIN | : 6 : PK |
| FIELD | = PRICING_ID | : LONG | : 1 |
| FIELD | = PRICE_TO_START | : LONG | : 1 |
| FIELD | = PRICE_TO_CONTINUE | : LONG | : 1 |
| FIELD | = START_DURATION | : LONG | : 1 |
| FIELD | = CONTINUE_DURATION | : LONG | : 1 |
| FIELD | = FLAGS | : BIN | : 1 |
| TABLE | = PROMOTION | | |
| FIELD | = RECORD_ID | : BIN | : 6 : PK |
| FIELD | = PROMOTION_ID | : LONG | : 1 |
| FIELD | = FLAGS | : BIN | : 1 |
| TABLE | = PROMOTION_COUPON | | |
| FIELD | = RECORD_ID | : BIN | : 6 : PK |
| FIELD | = PROMOTION_ID | : LONG | : 1 |
| FIELD | = COUPON_ID_TO_AWARD | : LONG | : 1 |
| FIELD | = FLAGS | : BIN | : 1 |
| TABLE | = PROMOTION_LOYALTY | | |
| FIELD | = RECORD_ID | : BIN | : 6 : PK |
| FIELD | = PROMOTION_ID | : LONG | : 1 |
| FIELD | = LOYALTY_PROGRAM_ID | : LONG | : 1 |
| FIELD | = NUM_POINTS_TO_AWARD | : SHORT | : 1 |
| FIELD | = FLAGS | : BIN | : 1 |
| TABLE | = REDEMPTION | | |
| FIELD | = RECORD_ID | : BIN | : 6 : PK |
| FIELD | = REDEMPTION_ID | | |
| FIELD | = FLAGS | : BIN | : 1 |
| FIELD | = MIN_RATING_ALLOWED | : BIN | : 1 |
| FIELD | = MAX_RATING_ALLOWED | : BIN | : 1 |
| FIELD | = SERVICE_ID | : LONG | : 1 |
| FIELD | = PROFILE | : BIN | : 1 |
| FIELD | = SHORT_NAME | : BIN | : 28 |
| FIELD | = NAME | : BIN | : 72 |
| FIELD | = PRICING_ID | : LONG | : 1 |
| FIELD | = START_DATE_TIME | : LONG | : 1 |
| FIELD | = END_DATE_TIME | : LONG | : 1 |
| FIELD | = SPONSOR | : BIN | : 40 |
| FIELD | = ICON | : LONG | : 1 |
| FIELD | = SPLASH_SCREEN | : LONG | : 1 |
| FIELD | = PERCENT_MONEY_TO_POOL | : BIN | : 1 |
| FIELD | = CURRENT_POOL_VALUE | : LONG | : 1 |
| FIELD | = VALUE_OF_AVAIL_PRIZES | : LONG | : 1 |
| FIELD | = PLAYS_TO_DATE | : LONG | : 1 |
| FIELD | = LAST_UPDATE_DATE_TIME | : LONG | : 1 |
| TABLE | = REDEMPTION_PAR_LEVEL | | |
| FIELD | = RECORD_ID | : BIN | : 6 : PK |
| FIELD | = REDEMPTION_ID | : LONG | : 1 |
| FIELD | = PAR_LEVEL | : BIN | : 1 |
| FIELD | = PAR_SCORE | : LONG | : 1 |
| FIELD | = TARGET_PAY_PERCENT | : BIN | : 1 |
| FIELD | = PRIZE_ITEM_ID | : LONG | : 1 |
| FIELD | = PERCENT_OF_POOL_{—APPLIED} | : BIN | : 1 |
| FIELD | = EXPIRATION_DATE | : LONG | : 1 |
| FIELD | = NUM_REMAINING | : LONG | : 1 |
| FIELD | = MIN_WIN_INTERVAL | : LONG | : 1 |
| FIELD | = FLAGS | : BIN | : 1 |
| FIELD | = MINOR_PRIOR_PLAYS | : LONG | : 1 |
| TABLE | = REDEMPTION_PROMOTION | | |
| FIELD | = RECORD_ID | : BIN | : 6 : PK |
| FIELD | = REDEMPTION_ID | : LONG | : 1 |
| FIELD | = PROMOTION_ID | : LONG | : 1 |
| FIELD | = FLAGS | : BIN | : 1 |
| FIELD | = PAR_LEVEL | : BIN | : 1 |
| TABLE | = REDEMPTION_RULE_SCREEN | | |
| FIELD | = RECORD_ID | : BIN | : 6 : PK |
| FIELD | = REDEMPTION_ID | : LONG | : 1 |
| FIELD | = SCREEN_INDEX | : BIN | : 1 |
| FIELD | = CONTENT_ID | : LONG | : 1 |
| FIELD | = FLAGS | : BIN | : 1 |
| TABLE | = REDEMPTION_SCHEDULE | | |
| FIELD | = RECORD_ID | : BIN | : 6 : PK |
| FIELD | = REDEMPTION_ID | : LONG | : 1 |
| FIELD | = TERMINAL_ID | : BIN | : 6 |
| FIELD | = SCHEDULE_ID | : LONG | : 1 |
| FIELD | = FLAGS | : BIN | : 1 |
| TABLE | = REDEMPTION_URC | | |
| FIELD | = RECORD_ID | : BIN | : 6 : PK |
| FIELD | = REDEMPTION_ID | : LONG | : 1 |
| FIELD | = URC | : LONG | : 1 |
| FIELD | = FLAGS | : BIN | : 1 |
| TABLE | = SCHEDULE | | |
| FIELD | = RECORD_ID | : BIN | : 6 : PK |
| FIELD | = SCHEDULE_ID | : LONG | : 1 |
| FIELD | = START_DATE_TIME | : LONG | : 1 |
| FIELD | = END_DATE_TIME | : LONG | : 1 |
| FIELD | = WEEKDAYS | : BIN | : 1 |
| FIELD | = START_TIME_OF_DAY | : LONG | : 1 |
| FIELD | = END_TIME_OF_DAY | : LONG | : 1 |
| FIELD | = FLAGS | : BIN | : 1 |
| TABLE | = SERVICE | | |
| FIELD | = RECORD_ID | : BIN | : 6 : PK |
| FIELD | = SERVICE_ID | : LONG | : 1 |
| FIELD | SERVICE_TYPE | : BIN | : 1 |
| FIELD | = FLAGS | : BIN | : 1 |
| FIELD | = SHORT_NAME | : BIN | : 30 |
| FIELD | = NAME | : BIN | : 72 |
| FIELD | = ICON | : LONG | : 1 |
| FIELD | = ATTRACT_SCREEN | : LONG | : 1 |
| FIELD | = SW_CAPABILITIES | : BIN | : 10 |
| FIELD | = NW_REQUIREMENTS | : BIN | : 10 |
| FIELD | = FILESET_ID | : LONG | : 1 |
| FIELD | = EXECUTABLE_FILE_ID | : LONG | : 1 |
| TABLE | = SERVICE_PROFILE | | |
| FIELD | = RECORD_ID | : BIN | : 6 : PK |
| FIELD | = SERVICE_ID | : LONG | : 1 |
| FIELD | = PROFILE | : BIN | : 1 |
| FIELD | = PROFILE_NAME | : BIN | : 40 |
| FIELD | = FLAGS | : BIN | : 1 |
| FIELD | = SCORE_FORMULA_LENGTH | : SHORT | : 1 |
| FIELD | = SCORE_FORMULA | : VARBIN | : 1 |
| TABLE | = SERVICE_PROFILE_SETTING | | |
| FIELD | = RECORD_ID | : BIN | : 6 : PK |
| FIELD | = SERVICE_ID | : LONG | : 1 |
| FIELD | = PROFILE | : BIN | : 1 |
| FIELD | = SETTING ID | : LONG | : 1 |
| FIELD | = SETTING_VALUE | : LONG | : 1 |
| FIELD | = FLAGS | : BIN | : 1 |
| TABLE | = SERVICE_PROMOTION | | |
| FIELD | = RECORD_ID | : BIN | : 6 : PK |
| FIELD | = SERVICE_ID | : LONG | : 1 |
| FIELD | = PROMOTION_ID | : LONG | : 1 |
| FIELD | = FLAGS | : BIN | : 1 |
| TABLE | = SERVICE_RATING | : BIN | : 6 : PK |
| FIELD | = RECORD_ID | : LONG | : 1 |
| FIELD | = SERVICE_ID | : LONG | : 1 |
| FIELD | = RATING | : BIN | : 1 |
| FIELD | = DESCRIPTION | : BIN | : 26 |
| FIELD | = FLAGS | : BIN | : 1 |
| TABLE | = SERVICE_SCHEDULE | | |
| FIELD | = RECORD_ID | : BIN | : 6 : PK |
| FIELD | = SERVICE_ID | : LONG | : 1 |
| FIELD | = TERMINAL_ID | : BIN | : 6 |
| FIELD | = SCHEDULE_ID | : LONG | : 1 |
| FIELD | = PROFILE | : BIN | : 1 |
| FIELD | = PRICING_ID | : LONG | : 1 |
| FIELD | = FLAGS | : BIN | : 1 |
| TABLE | = SERVICE_SETTING | | |
| FIELD | = RECORD_ID | : BIN | : 6 : PK |
| FIELD | = SERVICE_ID | : LONG | : 1 |
| FIELD | = SETTING_ID | : LONG | : 1 |
| FIELD | = SETTING_NAME | : BIN | : 32 |
| FIELD | = TYPE | : BIN | : 1 |
| FIELD | = FLAGS | : BIN | : 1 |
| TABLE | = SERVICE_SLOT | | |
| FIELD | = RECORD_ID | : BIN | : 6 : PK |
| FIELD | = SERVICE_ID | : LONG | : 1 |
| FIELD | = SLOT | : BIN | : 1 |
| FIELD | = SCHEDULE_ID | : LONG | : 1 |
| FIELD | = MUM_AD_PLAYS | : BIN | : 1 |
| FIELD | = FLAGS | : BIN | : 1 |
| TABLE | = SERVICE_STATISTIC | | |
| FIELD | = RECORD_ID | : BIN | : 6 : PK |
| FIELD | = SERVICE_ID | : LONG | : 1 |
| FIELD | = STATISTIC_ID | : LONG | : 1 |
| FIELD | = STATISTIC_NAME | : BIN | : 20 |
| FIELD | = LOWER_LIMIT | : LONG | : 1 |
| FIELD | = UPPER_LIMIT | : LONG | : 1 |
| FIELD | = FLAGS | : BIN | : 1 |
| TABLE | = SERVICE_TERMINAL | | |
| FIELD | = RECORD_ID | : BIN | : 6 : PK |
| FIELD | = SERVICE_ID | : LONG | : 1 |
| FIELD | = TERMINAL_ID | : BIN | : 6 |
| FIELD | = LICENSE_KEY | : BIN | : 16 |
| FIELD | = FILESET_ID | : LONG | : 1 |
| FIELD | = FLAGS | : BIN | : 1 |
| TABLE | = SERVICE_TYPE | | |
| FIELD | = RECORD_ID | : BIN | : 6 : PK |
| FIELD | = TYPE | : BIN | : 1 |
| FIELD | = PARENT_TYPE | : BIN | : 1 |
| FIELD | = TYPE_NAME | : BIN | : 16 |
| FIELD | = FLAGS | : BIN | : 1 |
| TABLE | = SERVICE_URC | | |
| FIELD | = RECORD_ID | : BIN | : 6 : PK |
| FIELD | = SERVICE_ID | : LONG | : 1 |
| FIELD | = URC | : LONG | : 1 |
| FIELD | = FLAGS | : BIN | : 1 |
| TABLE | = SUBSCRIBER | | |
| FIELD | = RECORD_ID | : BIN | : 6 : PK |
| FIELD | = SUBSCRIBER_ID | : LONG | : 1 |
| FIELD | = ALIAS | : BIN | : 26 |
| FIELD | = FIRST_NAME | : BIN | : 20 |
| FIELD | = LAST_NAME | : BIN | : 20 |
| FIELD | = MIDDLE_INITIAL | : BIN | : 2 |
| FIELD | = STREET_ADDRESS | : BIN | : 40 |
| FIELD | = POSTAL_CODE | : BIN | : 10 |
| FIELD | = PHONE_NUMBER | : 10 | |
| FIELD | = BIRTH_DAY | : BIN | : 1 |
| FIELD | = BIRTH_MONTH | : BIN | : 1 |
| FIELD | = BIRTH_YEAR | : SHORT | : 1 |
| FIELD | = GENDER | : BIN | : 1 |
| FIELD | = FLAGS | : BIN | : 1 |
| FIELD | = DEMOGRAPHIC | : LONG | : 1 |
| FIELD | = LAST_UPDATE_DATE_TIME | : LONG | : 1 |
| TABLE | = SUBSCRIBER_AD | | |
| FIELD | = RECORD_ID | : BIN | : 6 : PK |
| FIELD | = SUBSCRIBER_ID | : LONG | : 1 |
| FIELD | = AD_ID | : LONG | : 1 |
| FIELD | = VIEW_DATE_TIME | | |
| FIELD | = FLAGS | : BIN | : 1 |
| TABLE | = SUBSCRIBER_AVATAR | | |
| FIELD | = RECORD_ID | : BIN | : 6 : PK |
| FIELD | = SUBSCRIBER_ID | : LONG | : 1 |
| FIELD | = AVATAR_TYPE | : BIN | : 1 |
| FIELD | = CONTENT_ID | : LONG | : 1 |
| FIELD | = FLAGS | : BIN | : 1 |
| TABLE | = SUBSCRIBER_BRACKET | | |
| FIELD | = RECORD_ID | : BIN | : 6 : PK |
| FIELD | = SUBSCRIBER_ID | : LONG | : 1 |
| FIELD | = TOURNAMENT_ID | : LONG | : 1 |
| FIELD | = BRACKET_ID | : BIN | : 1 |
| FIELD | = GAMES_PLAYED | : SHORT | : 1 |
| FIELD | = FLAGS | : BIN | : 1 |
| FIELD | = RANK | : LONG | : 1 |
| FIELD | = RANK_DATE_TINE | : LONG | : 1 |
| FIELD | = RANK_SCORE | : LONG | : 1 |
| FIELD | = AVERAGE_SCORE | : LONG | : 1 |
| TABLE | = SUBSCRIBER_CARD | | |
| FIELD | = RECORD_ID | : BIN | : 6 : PK |
| FIELD | = SUBSCRIBER_ID | | |
| FIELD | = CARD_TYPE | : BIN | : 1 |
| FIELD | = CARD_DATA | : BIN | : 16 |
| FIELD | = FLAGS | : BIN | : 1 |
| TABLE | = SUBSCRIBER_RATING | | |
| FIELD | = RECORD_ID | : BIN | : 6 : PK |
| FIELD | = SUBSCRYBER_ID | : LONG | : 1 |
| FIELD | = SERVICE_ID | : LONG | : 1 |
| FIELD | = PROFILE | : BIN | : 1 |
| FIELD | = RATING | : BIN | : 1 |
| FIELD | = HANDICAP | : LONG | : 1 |
| FIELD | = PLAYS_TO_QUALIFY | : BIN | : 1 |
| FIELD | = FLAGS | : BIN | : 1 |
| TABLE | = SUBSCRIBER_SAVE_STATE | | |
| FIELD | = RECORD_ID | : BIN | : 6 : PK |
| FIELD | = SUBSCRIBER_ID | : LONG | : 1 |
| FIELD | = SERVICE_ID | : LONG | : 1 |
| FIELD | = SLOT_NUMBER | : BIN | : 1 |
| FIELD | = PROFILE | : BIN | : 1 |
| FIELD | = SAVE_STATE_NAME | : BIN | : 20 |
| FIELD | = DATA_FILE_ID | : LONG | : 1 |
| FIELD | = FLAGS | : BIN | : 1 |
| TABLE | = SUBSCRIBER_URC | | |
| FIELD | = RECORD_ID | : BIN | : 6 : PK |
| FIELD | = SUBSCRIBER_ID | : LONG | : 1 |
| FIELD | = URC | : LONG | : 1 |
| FIELD | = FLAGS | : BIN | : 1 |
| TABLE | = TEAM_MEMBER | | |
| FIELD | = RECORD_ID | : BIN | : 6 : PK |
| FIELD | = TEAM_SUBSCRIBER_ID | : LONG | : 1 |
| FIELD | = SUBSCRIBER_ID | : LONG | : 1 |
| FIELD | = FLAGS | : BIN | : 1 |
| TABLE | = TECHNICIAN | | |
| FIELD | = RECORD_ID | : BIN | : 6 : PK |
| FIELD | = TECHNICIAN_ID | : LONG | : 1 |
| FIELD | = NAME | : BIN | : 26 |
| FIELD | = PIN | : SHORT | : 1 |
| FIELD | = FLAGS | : BIN | : 1 |
| TABLE | = TECHNICIAN_TERMINAL | | |
| FIELD | = RECORD_ID | : BIN | : 6 : PK |
| FIELD | = TECHNICIAN_ID | : LONG | : 1 |
| FIELD | = TERMINAL_ID | : BIN | : 6 |
| FIELD | = AUTHORIZATION_FLAGS | : BIN | : 1 |
| TABLE | = TERMINAL | | |
| FIELD | = RECORD_ID | : BIN | : 6 : PK |
| FIELD | = TERMINAL_ID | : BIN | : 6 |
| FIELD | = LOCATION_ID | : LONG | : 1 |
| FIELD | = LAN_ADDRESS | : BIN | : 4 |
| FIELD | = FLAGS | : BIN | : 1 |
| FIELD | = SERIAL_NUMBER | : BIN | : 20 |
| FIELD | = HW_CAPABILITIES | : BIN | : 10 |
| FIELD | = ATTRACT_SCREEN | : LONG | : 1 |
| FIELD | = SYSTEM_FILESET_ID | : LONG | : 1 |
| TABLE | = TOURNAMENT | | |
| FIELD | = RECORD_ID | : BIN | : 6 : PK |
| FIELD | = TOURNAMENT_ID | : BIN | : 28 |
| FIELD | = SHORT_NAME | | |
| FIELD | = NAME | : BIN | : 72 |
| FIELD | = START_DATE_TINE | : LONG | : 1 |
| FIELD | = END_DATE_TIME | : LONG | : 1 |
| FIELD | = TOURNAMENT_SCOPE | : BIN | : 1 |
| FIELD | = FLAGS | : BIN | : 1 |
| FIELD | = SPONSOR | : BIN | : 40 |
| FIELD | = ICON | : LONG | : 1 |
| FIELD | = SPLASH_SCREEN | : LONG | : 1 |
| FIELD | = PERCENT_MONEY_TO_POOL | : BIN | : 1 |
| FIELD | = CURRENT_POOL_VALUE | : LONG | : 1 |
| FIELD | = PLAYS_TO_DATE | : LONG | : 1 |
| FIELD | = LAST_UPDATE_DATE_TIME | : LONG | : 1 |
| TABLE | = TOURNAMENT_URC | | |
| FIELD | = RECORD_ID | : BIN | : 6 : PK |
| FIELD | = TOURNAMENT_ID | : LONG | : 1 |
| FIELD | = URC | : LONG | : 1 |
| FIELD | = FLAGS | : BIN | : 1 |
| TABLE | = URC_VALUE | | |
| FIELD | = RECORD_ID | : BIN | : 6 : PK |
| FIELD | = URC | : LONG | : 1 |
| FIELD | = RESTRICTED_STRING | : BIN | : 30 |
| FIELD | = FLAGS | : BIN | : 1 |

# Working tables - not replicated from EDS server

| | | | |
|---|---|---|---|
| TABLE | = W_AD_EXPOSURE | | |
| FIELD | = RECORD_ID | : LONG | : 1 : PK |
| FIELD | = TARGET_ID | : LONG | : 1 |
| FIELD | = SUBSCRIBER_ID | : LONG | : 1 |
| FIELD | = PLAY_DATE_TIME | : LONG | : 1 |
| TABLE | = W_AD_EXPOSURE_COUNTS | | |
| FIELD | = RECORD_ID | : LONG | : 1 : PK |
| FIELD | = TARGET_ID | : LONG | : 1 |
| FIELD | = TOTAL_PLAYS_TODAY | : SHORT | : 1 |
| FIELD | = TOTAL_PLAYS_TO_DATE | : LONG | : 1 |
| TABLE | = W_CONTENT_CACHE | | |
| FIELD | = RECORD_ID | : LONG | : 1 : PK |
| FIELD | = CONTENT_ID | : LONG | : 1 |
| FIELD | = LOCAL_PATH_SIZE | : SHORT | : 1 |
| FIELD | = LOCAL_PATH | : VARBIN | : 1 |
| TABLE | = W_COUPONS_ISSUED | | |
| FIELD | = RECORD_ID | : LONG | : 1 : PK |
| FIELD | = COUPON_ID | : LONG | : 1 |
| FIELD | = RECEIPT_ID | : BIN | : 6 |
| FIELD | = TERMINAL_ID | : BIN | : 6 |
| FIELD | = SUBSCRIBER_ID | : LONG | : 1 |
| FIELD | = ISSUE_DATE_TIME | : LONG | : 1 |
| FIELD | = FLAGS | : BIN | : 1 |
| TABLE | = W_DOWN_TIME | | |
| FIELD | = RECORD_ID | : LONG | : 1 : PK |
| FIELD | = START_DATE_TIME | : LONG | : 1 |
| FIELD | = END_DATE TIME | : LONG | : 1 |
| FIELD | = TECHNICIAN_ID | : LONG | : 1 |
| TABLE | = W_FILE_CACH | | |
| FIELD | = RECORD_ID | : LONG | : 1 : PK |
| FIELD | = FILE_ID | : LONG | : 1 |
| FIELD | = LOCAL_PATH_SIZE | : SHORT | : 1 |
| FIELD | = LOCAL_PATH | : VARBIN | : 1 |
| TABLE | = W_LEADERBOARD | | |
| FIELD | = RECORD_ID | : LONG | : 1 : PK |
| FIELD | = LEADERBOARD_ID | : LONG | : 1 |
| FIELD | = LEADERBOARD_DATE_TIME | : LONG | : 1 |
| FIELD | = FLAGS | : BIN | : 1 |
| FIELD | = MAX_LEADERS | : SHORT | : 1 |
| TABLE | = W_LEADERBOARD_LEADER | | |
| FIELD | = RECORD_ID | : LONG | : 1 : PK |
| FIELD | = LEADERBOARD_ID | : LONG | : 1 |
| FIELD | = SUBSCRIBER_ID | : LONG | : 1 |
| FIELD | = ALIAS | : BIN | : 26 |
| FIELD | = LOCATION_NAME | : BIN | : 26 |
| FIELD | = LOCATION_CITY_STATE | : BIN | : 26 |
| FIELD | = PRIZE_NAME | : BIN | : 26 |
| FIELD | = SCORE | : LONG | : 1 |
| FIELD | = SCORE_DATE_TIME | : LONG | : 1 |
| TABLE | = W_LEADERBOARD_RANKING | | |
| FIELD | = RECORD_ID | : LONG | : 1 : PK |
| FIELD | = LEADERBOARD_ID | : LONG | : 1 |
| FIELD | = RANK | : SHORT | : 1 |
| FIELD | = SUBSCRIBER_ID | : LONG | : 1 |
| TABLE | = W_LOCAL_LEADERBOARD | | |
| FIELD | = RECORD_ID | : LONG | : 1 : PK |
| FIELD | = LEADERBOARD_ID | : LONG | : 1 |
| FIELD | = LEADERBOARD_DATE_TIME | : LONG | : 1 |
| FIELD | = MAX_LEADERS | : SHORT | : 1 |
| TABLE | = W_LOCAL_LEADER | | |
| FIELD | = RECORD_ID | : LONG | : 1 : PK |
| FIELD | = LEADERBOARD_ID | : LONG | : 1 |
| FIELD | = RANK | : SHORT | : 1 |
| FIELD | = SUBSCRIBER_ID | : LONG | : 1 |
| FIELD | = ALIAS | : BIN | : 26 |
| FIELD | = SCORE | : LONG | : 1 |
| FIELD | = SCORE_DATE_TIME | : LONG | : 1 |
| TABLE | = W_LOYALTY_POINT_AWARDS | | |
| FIELD | = RECORD_ID | : LONG | : 1 : PK |
| FIELD | = SUBSCRIBER_ID | : LONG | : 1 |
| FIELD | = LOYALTY_PROGRAM_ID | : LONG | : 1 |
| FIELD | = POINTS_AWARDED | : SHORT | : 1 |
| FIELD | = AWARD_DATE_TIME | : LONG | : 1 |
| TABLE | = W_QUEUE | | |
| FIELD | = RECORD_ID | : LONG | : 1 : PK |
| FIELD | = TERMINAL_ID | : BIN | : 6 |
| FIELD | = AGE | : SHORT | : 1 |
| FIELD | = QUEUE_TIME | : LONG | : 1 |
| FIELD | = EVENT_TYPE | : BIN | : 1 |
| FIELD | = EVENT_DATA_SIZE | : SHORT | : 1 |
| FIELD | = EVENT_DATA | : VARBIN | : 1 |
| TABLE | = W_REDEMPTION_HISTORY | | |
| FIELD | = RECORD_ID | : LONG | : 1 : PK |
| FILED | = REDEMPTION_ID | : LONG | : 1 |
| FIELD | = TIMESTAMP | : LONG | : 1 |
| FIELD | = SCORE | : LONG | : 1 |
| FIELD | = PAR_LEVEL_PAID | : BIN | : 1 |
| FIELD | = SUBSCRIBER_ID | : LONG | : 1 |
| FIELD | = CASH_AMOUNT_PAID | : LONG | : 1 |
| TABLE | = W_REDEMPTION_LOCAL_POOL | | |
| FIELD | = RECORD_ID | : LONG | : 1 : PK |
| FILED | = REDEMPTION_ID | : LONG | : 1 |
| FIELD | = LOCAL_POOL_VALUE | : LONG | : 1 |
| TABLE | = W_REDEMPTION_PAR_LEVEL | | |
| FIELD | = RECORD_ID | : LONG | : 1 : PK |
| FILED | = REDEMPTION_ID | : LONG | : 1 |
| FIELD | = PAR_LEVEL | : BIN | : 1 |
| FIELD | = ADJUSTED_PAR_SCORE | : LONG | : 1 |
| TABLE | = W_SERVICE_ACCESSES | | |
| FIELD | = RECORD_ID | : LONG | : 1 : PK |
| FIELD | = SERVICE_ID | : LONG | : 1 |
| FIELD | = PROFILE | : BIN | : 1 |
| FIELD | = START_DATE_TIME | : LONG | : 1 |
| FIELD | = END_DATE_TIME | : LONG | : 1 |
| FIELD | = SUBSCRIBE_ID | : LONG | : 1 |
| FIELD | = CASH_FUNDS_USED | : LONG | : 1 |
| FIELD | = ACCOUNT_FUNDS_USED | : LONG | : 1 |
| TABLE | W_SERVICE_LEADERBOARD | | |
| FIELD | RECORD_ID | : LONG | : 1 |
| FIELD | SERVICE_ID | : LONG | : 1 |
| FIELD | PROFILE | : BIN | : 1 |
| FIELD | LEADERBOARD_ID | : LONG | : 1 |
| TABLE | W_TOURNAMENT_LOCAL_POOL | | |
| FIELD | RECORD_ID | : LONG | : 1 : PK |
| FIELD | TOURNAMENT_ID | : LONG | : 1 |
| FIELD | LOCAL_POOL_VALUE | : LONG | : 1 |

We claim:

1. A system for controlling a customer reward system comprising:
(a) a first database for storing customer identifications, and for accumulated loyalty points awarded to the customer,
(b) an administration terminal for establishing loyalty point values associated with any of plural predetermined activities, and for storing the values and identities of associated activities, in a second database,
(c) a reading terminal for reading the identity of a customer at a location of the terminal,
(d) first apparatus located in the region of the reading terminal for detecting an activity of the customer, and
(e) second apparatus for accessing the second database, looking up the activity of the customer, and depositing corresponding loyalty points in the first database in association with an identification of the customer.

2. A system as defined in claim 1, including a game terminal for detecting an activity of the customer which is the achievement of a particular score range on the game terminal and reporting the score to said second apparatus.

3. A system as defined in claim 1, in which said first apparatus offers at least one of goods and services to a customer, and for reporting accessing of the at least one of goods and services by the customer to said second apparatus.

4. A system as defined in claim 3 including apparatus for loading the second database to a decision support server memory, and further including a regional server for storing the first database and for accessing the second database in the decision support server from time to time to obtain said established loyalty point values associated with said predetermined activities.

5. A system as defined in claim 4, the decision support server optimizing database data for transmission to plural regional servers and for propagating the database data to the plural regional servers from time to time.

6. A system as defined in claim 5 in which the first apparatus is a game terminal, the game terminal detecting an activity of the customer which is the achievement of a particular score range on the game terminal and reporting the score to an associated regional terminal.

7. A system as defined in claim 6, wherein the second database includes handicap specifying parameters, and in which the decision support server accesses the handicap parameters associated with a particular player or demographic or with a game, and optionally accesses a loyalty point parameter to be awarded for the achievement of the score, and the decision support server providing the handicap parameter and optionally the loyalty points to an associated regional server for computing and storing at least one of a handicapped score and loyalty points in the first database in association with the identification of the customer.

8. A system as defined in claim 4 in which the decision support server operates in real time with the regional server.

9. A system as defined in claim 4 for downloading data from the first database to the second database which at least differs from data stored at the second database, from time to time.

10. A system as defined in claim 4 for replicating predetermined data stored in the second database, to the first database from time to time.

11. A system as defined in claim 3 in which the accessing of the at least one of the goods and services by the customer causes decrementing of loyalty points stored in association with the customer identification, of a number of loyalty points predetermined at the administrator terminal and stored in the second database.

12. A system as defined in claim 3, including a printer associated with at least one of the reading terminal and second apparatus, for printing and dispensing a coupon having an imprinted value and optionally a product or service indicator thereon under control of parameters specified on the administrator terminal and stored at least in the second database, the value and optional product or service being stored in the first database in association with a customer identification.

13. A system as defined in claim 12, including a coupon redemption input device, the second apparatus for accessing the first database for checking the read coupons, providing an acceptance or refusal indication, and in the case of acceptance, either marking the coupon in the first database as used or deleting record of the coupon.

14. A system as defined in claim 13, the second apparatus for providing an acceptance indication as a start signal to an automatic service or product dispensing machine.

15. A system as defined in claim 14 in which the automatic service dispensing machine is one of a game, a public PC, a vending machine, a pay-phone or a video-phone.

16. A system as defined in claim 1 in which the administrator terminal is comprised of plural terminals at least some of which are disposed at remote locations.

17. A method of controlling a customer reward system comprising:
(a) distributing identification elements to prospective customers each of which store unique customer identifications,
(b) detecting the presence of an identification element at a terminal,
(c) receiving and storing at least one of currency credits, loyalty points credits and coupon credits in a database record associated with a customer identification based on at least one of a currency deposit and an activity undertaken by a customer,
the loyalty points and coupon credits being predetermined by an administrator and are variable depending on the activity undertaken by the customer and at least one of: an identity of a merchant or machine providing a product or a service, a total number or incremental number or skill level or persons which previously availed themselves of a product or service, an advertisement presented on a display located adjacent to an identified customer, a time interval or the real time when the product or service is provided, a skill bracket or handicapped skill achieved by the customer of an activity, a handicap attributed to a machine which provides a product or service, an interval since an activity was undertaken by the customer or by other customers or by customers of a particular demographic profile, a classification in which the customer belongs, and a demographic profile of the customer.

18. A method as defined in claim 17 including storing parameters defined by the administrator for determining at least one of loyalty points and coupon credits, and providing the parameters to a server for calculation of credits and coupons for distribution to customer records upon determination of a particular activity having been undertaken by the customer.

19. A method as defined in claim 18 including receiving at a terminal the identity of a customer and a request to redeem at least one of loyalty points and a coupon for at least one of a service, goods or currency, checking the database record associated with the identity of the customer, sending an authorization signal to the terminal, and using the authorization signal to control provision of the service, goods or currency to the identified customer.

20. A method of controlling a customer reward system comprising:
(a) distributing identification elements to prospective customers each of which store unique customer identifications,
(b) detecting the presence of an identification element at a terminal,
(c) receiving and storing loyalty point credits in a database record associated with a customer identification based on at least one of a currency deposit and an activity undertaken by a customer,
(d) redeeming loyalty point credits by any of plural unrelated merchants at any of plural redemption terminals,
(e) reporting loyalty point credits and redemptions undertaken by each of the plural merchants to an administrator terminal via a communication network, and
(f) settling credits and redemptions of loyalty points from time to time as between the merchants and administrator,
whereby the loyalty points are used as a medium of exchange between the merchants and administrator via the network and the terminals.

21. A method as defined in claim 20, in which the loyalty points and coupon credits are predetermined by the administrator terminal and are variable depending on the activity undertaken by the customer and at least one of: an identity of a merchant or machine providing a product or a service, a total number or incremental number or skill level or persons which previously availed themselves of a product or service, a time interval or the real time when the product or service is provided, a skill bracket or handicapped skill achieved by the customer of an activity, a handicap attributed to a machine which provides a product or service, an interval since an activity was undertaken by the customer or by other customers or by customers of a particular demographic profile, and a demographic profile of the customer.

22. A method for controlling a customer reward system comprising:
(a) establishing merchant, customer and administrator loyalty point databases,
(b) depositing loyalty points in a designated customer's database or in plural customer databases,
(c) redeeming loyalty points of a customer by a merchant providing a goods or services, and decrementing the database of the customer by a predetermined number of loyalty points and incrementing the database of the merchant by the predetermined number of loyalty points,
(d) decrementing a further predetermined number of loyalty points from the database of the merchant and incrementing the database of the administrator by the further predetermined number of loyalty points.

23. A method as defined in claim 22, and from time to time, settling values of loyalty points to monetary, merchandise or services values as between merchants and the administrator.

24. A method as defined in claim 22, including incrementing the database of specific customers with additional loyalty points based on predetermined activities undertaken by the specific customers.

25. A method as defined in claim 22, including decrementing loyalty points from the database of a merchant, and incrementing the number of loyalty points held in the database of the customer, upon a customer purchasing goods or services from the merchant, and incrementing the number of loyalty points held in the database of the customer.

26. A method as defined in claim 22 including running an advertisement on behalf of an advertising merchant, decrementing loyalty points from the database of the advertising merchant upon running the advertisement and incrementing the database of the administrator by the number of loyalty points decremented from the latter merchant due to running the advertisement.

27. A method as defined in claim 26, including identifying a customer adjacent a display or loudspeaker which can run the advertisement, and incrementing the database of the identified customer with a predetermined number of loyalty points upon reproducing the advertisement by the display or loudspeaker.

28. A method for controlling a customer reward system comprising:
(a) establishing merchant, customer and administrator loyalty point databases,
(b) depositing loyalty points in a designated customer's database or in plural customer databases,
(c) redeeming loyalty points of a customer by a merchant providing a goods or services, and decrementing the database of the customer by a first predetermined number of loyalty points and incrementing the database of the administrator by the first predetermined number of loyalty points, and
(d) decrementing a further predetermined number of loyalty points from the database of the administrator which is smaller than the first predetermined number of loyalty points and incrementing the database of the merchant by the further predetermined number of loyalty points.

29. A method as defined in claim 28, and from time to time, settling values of loyalty points to monetary, merchandise or services values as between merchant and the administrator.
